(19) United States
(12) Patent Application Publication
(10) Pub. No.: US 2014/0104196 A1
(43) Pub. Date: Apr. 17, 2014

(54) CURVED PROFILE TOUCH SENSOR SYSTEMS AND METHODS

(71) Applicant: ELO TOUCH SOLUTIONS, INC., Menlo Park, CA (US)

(72) Inventors: Steven W. HAUNGS, Mountain View, CA (US); James L. AROYAN, Santa Cruz, CA (US); Daniel H. SCHARFF, San Leandro, CA (US); Joel C. KENT, Fremont, CA (US)

(73) Assignee: ELO TOUCH SOLUTIONS, INC., Menlo Park, CA (US)

(21) Appl. No.: 13/688,149

(22) Filed: Nov. 28, 2012

Related U.S. Application Data
(60) Provisional application No. 61/714,187, filed on Oct. 15, 2012.

(51) Int. Cl. G06F 3/041

(52) U.S. Cl. CPC G06F 3/041
USPC 345/173

(57) ABSTRACT

Systems and related methods providing for touch sensors having at least one non-linear edge. A touch sensor may include a substrate configured to propagate surface acoustic waves. The substrate may include a front surface, a back surface including a reflective array, and a connecting surface joining the front surface and the back surface. The front surface may define a front bowed edge and the back surface may define a back bowed edge. The connecting surface may be between the front bowed edge and the back bowed edge. The reflective array may be configured to cause the surface acoustic waves to propagate from the back surface, is the connecting surface, to the front surface. The touch system may further include circuitry configured to determine a coordinate of a touch event on the front surface based on received attenuations in the surface acoustic waves.

### FIELD

Embodiments discussed herein are related to, in general, touch sensors using surface acoustic waves to detect a touch event.

### BACKGROUND

Touch sensor systems, such as those used with display screens to form touch/displays, may act as input devices for interactive computer systems. Such systems may also be used for applications such as information kiosks, computers, order entry systems for restaurants, video displays or signage, mobile devices, etc. By integrating a touch sensor system into a computing device, the computer may provide a user an intuitive, interactive human-machine-interface.

Currently, a variety of touch sensor technologies are implemented in different types of machines. These touch technologies are built on resistive, capacitive, and acoustic properties of various components. Acoustic touch sensors, such as ultrasonic touch sensors using surface acoustic waves, are particularly advantageous when the application demands a very durable touch sensitive surface and minimal optical degradation of the displayed image.

Commercially, the cosmetic look and industrial design of touch devices as well as the robustness and reliability of feature capabilities of such devices is becoming increasingly important. However, the components, physics, and other scientific principles that are leveraged to provide such functionality often inhibit or even degrade the aesthetics that are desirable. Through applied effort, ingenuity, and innovation, many of these identified problems have been solved by developing solutions that are included in embodiments of the present invention, some examples of which are described herein.

### BRIEF SUMMARY

Systems and related methods are provided related to, in general, touch sensors having at least one non-linear edge, which may be manufactured in relatively larger sizes, such as those desired for interactive digital signage. For example, some embodiments may include an acoustic touch apparatus comprising a substrate configured to propagate surface acoustic waves. The substrate may have a front surface, a back surface, and a connecting surface joining the front surface and the back surface. A reflective array, as well as one or more transducers configured to generate a surface acoustic wave, may be positioned on the front and/or back surface(s). The front and back surfaces may define respectively a front and back bowed edges, or flat surface perimeters, between which the connecting surface may be defined. As such, surface acoustic waves may propagate from the back surface to the front surface or vice-versa) via the connecting surface. In some embodiments, the connecting surface may be rounded or otherwise curved to aid in facilitating propagation of the acoustic surface waves.

The acoustic wave transducer may be configured to generate and initiate the propagation of acoustic waves in a prevailing direction along an associated reflective array. As used herein, a “beginning” of a reflective array refers to an array portion that is closer to an associated acoustic wave transducer and an “end” of the reflective array refers to an array portion that is further from the associated acoustic wave transducer. The direction defined from the beginning of the reflective array to the end of the reflective array is sometimes referred to herein as the “prevailing direction” along the reflective array.

In some embodiments, the reflective array may include a plurality of reflector elements disposed from the beginning to the end of the reflective array. In some embodiments, the distances between pairs of the reflector elements may vary throughout the reflective array. For example, the distances between pairs of reflector elements may become, in general, smaller relative to the prevailing direction from the beginning of the reflective array to the end of the reflective array. The spacing distances between reflective elements may impact the strength of the acoustic signal that travels through the sensor, which is eventually transformed into an electrical signal generated by a receiving transducer.

In some embodiments, a spacing quantum may be provided between pairs of the reflector elements. The spacing quantum may vary throughout the reflective array. For example, the spacing quantum between pairs of reflector elements may become larger relative to the prevailing direction. In another example, the spacing quantum between pairs of reflector elements may become smaller relative to the prevailing direction.

In some embodiments, each of the reflector elements may be positioned with a specific reflector angle. The reflector angles, defined as the angle between a reflector and the array axis, may differ for some or all of the reflector elements of the reflective array. For example, the reflector angles may become smaller for successive reflector elements relative to the beginning of the reflective array to the end of the reflective array. In another example, the reflector angles may become larger for successive reflector elements relative to the beginning of the reflective array to the end of the reflective array.

In some embodiments, the front and/or back bowed edge(s) may define a convex curvature. Additionally or alternatively, the front and/or back bowed edge(s) may define a concave curvature. In yet other embodiments, the front and/or back bowed edge(s) may define a plurality of curved and/or straight edges.

In some embodiments, the front surface may include a touch region. The acoustic touch apparatus may further include a controller configured to determine a coordinate of a touch event that occurs on the touch region. The touch event may be located based on detected waveform attenuations of the surface acoustic waves. For example, a time function may be used to correlate a waveform attenuation in a received return signal (e.g., relative to the duration of a received return signal) with a location on the touch region. The controller may be configured to receive the return signal from a receiving acoustic wave transducer coupled thereto. For example, a return surface acoustic wave may be comprised of a plurality of rays that each had a different propagation time between a transmitting acoustic wave transducer and a receiving acoustic wave transducer. The controller may be configured to determine the coordinate of a touch on the touch region based on detected waveform attenuations of the surface acoustic waves as a function of time adjusted for the different propagation times.

The transmitting acoustic wave transducer and the receiving acoustic wave transducer may be comprised in a single integrated acoustic wave transceiver. Alternatively or additionally, the transmitting acoustic wave transducer and the receiving acoustic wave transducer may be comprised in two separate acoustic wave transducers.

In some embodiments, the acoustic touch apparatus may include a display device positioned such that the display device is visible through the front surface of the substrate. As such, the front surface may have no bezel or, in other words, be “bezelless” or “bezel-free.”

In some embodiments, an acoustic wave transducer and the reflective array are coupled to the back surface via an acoustically benign layer on the back surface. In some examples, the acoustically benign layer may comprise an opaque ink coating.

Some embodiments may include a method of determining a coordinate of a touch event on a sensor. The method may include: generating an electrical excitation signal; transmitting the electrical excitation signal to a transmitting transducer that is configured to transform the electrical excitation signal into at least one acoustic wave; receiving an electrical return signal from a receiving transducer that is configured to transform the acoustic wave into the electrical return signal, wherein the electrical return signal represents the acoustic wave including an attenuation that occurred while propagating through the sensor having the non-linear edge: and processing, by circuitry, the electrical return signal.

In some embodiments, processing the electrical return signal may comprise: determining a relative timing of the attenuation and mapping the relative timing to a coordinate of the sensor having the non-linear edge. The mapping may use a non-linear function associated with how the acoustic wave is expected to travel relative to time from the transmitting transducer to the receiving transducer via the non-linear edge of the sensor. The coordinate may at least partially represent a physical location on the sensor where the attenuation occurred.

In some embodiments, the method may further include: associating, with the circuitry, the coordinate with a display element shown on a display device, the display device configured to present the display element while the acoustic wave propagates through the sensor. In some examples, associating the coordinate with the display element comprises determining a user has indicated a desire to select the display element.

The method may also include: generating a second electrical excitation signal; transmitting the second electrical excitation signal to a second transmitting transducer that is configured to transform the second electrical excitation signal into at least one second acoustic wave; receiving a second electrical return signal from a second receiving transducer that is configured to transform the second acoustic wave into the second electrical return signal, wherein the second electrical return signal represents the second acoustic wave including a second attenuation that occurred while propagating through the sensor; and processing, by the circuitry, the second electrical return signal.

In some embodiments, processing the second electrical return signal may include: determining a relative timing of the second attenuation and mapping the relative timing of the second attenuation to a second coordinate of the sensor having the non-linear edge, wherein the mapping uses a second function representing how the second acoustic wave is expected to travel relative to time from the second transmitting transducer to the second receiving transducer via a second edge of the sensor. The second coordinate may at least partially represent a physical location on the sensor where the second attenuation occurred, and the coordinate and the second coordinate may define a coordinate pair of the touch event.

In some examples, the second function is a linear function and the second edge is linear. In other examples, the second function is a non-linear function and the second edge is non-linear, in some embodiments, the second non-linear function may be different from the first non-linear function.

In some embodiments, the method may further include: associating, with the circuitry, the coordinate pair with a display element shown on a display device. The display device may be configured to present the display element while the acoustic wave and the second acoustic wave propagate through the sensor.

In some embodiments, associating the coordinate pair with the display element may include determining a user has indicated a desire to select the display element.

In embodiments using the non-linear function, the non-linear function may be associated with the non-linear edge and the non-linear edge may be a bowed edge of the sensor. The non-linear function may be stored in a memory.

Some embodiments may include an apparatus configured to implement the method and/or other functionality discussed herein. In other words, the apparatus may include one or more processors and/or other machine components configured to implement the functionality discussed herein based on instructions and/or other data stored in memory and/or other non-transitory computer readable media.

Some embodiments may include a method of manufacturing, an acoustic touch apparatus and/or other types of touch-sensitive products and components. The method may include providing a substrate configured to propagate surface acoustic waves. For example, the substrate may comprise one or more materials, such as some types of glass and/or inks that are suitable for propagating acoustic waves, some examples of which are discussed below. The substrate may include a front surface a back surface, and a connecting surface joining the front surface and the back surface. The method may further include: defining the front surface to have a front bowed edge; defining the back surface to have a back bowed edge (e.g., cutting a piece of glass to have a curved edge), wherein the connecting surface is between the front bowed edge and the back bowed edge is curved (e.g., at least partially rounded after cutting). A reflective array may be provided (e.g., screen printed, etched, painted on, or otherwise formed) on the back surface of the substrate, wherein the reflective array is configured to cause the surface acoustic waves to propagate from the back surface, via the connecting surface, to the front surface.

In some embodiments, forming the reflective array may include forming a plurality of reflector elements disposed from the beginning to the end of the reflective array. The distances between pairs of the reflector elements may vary between the beginning and the end of the reflective array. In some embodiments, each of the reflector elements may have a reflector angle and reflector angles for at least two reflector elements are different.

In some embodiments, cutting the substrate to have the bowed front edge and the bowed back edge may define a convex curvature. Additionally or alternatively, cutting the substrate to have the bowed front edge and the bowed back edge may define a concave curvature. In some embodiments, the method may further include applying an acoustically benign layer that is opaque prior to forming the reflective array. Forming the reflective array may be performed on the applied acoustically benign layer. Some embodiments may include an acoustic touch apparatus prepared by the methods discussed herein.

These characteristics as well as additional features, functions, and details of the present invention are described below. Similarly, corresponding and additional embodiments are also described below.

### BRIEF DESCRIPTION OF THE DRAWINGS

Having thus described the invention in general terms, reference will now be made to the accompanying drawings, which are not necessarily drawn to scale, and wherein:

FIG. 1a shows an example of a simplified cross-sectional view of an touch sensor, configured in accordance with some embodiments;

FIGS. 1b and 1c show example of how an acoustic wave travels around a curved connecting surface in some embodiments;

FIGS. 2a and 2b, respectively, show front and back views of an example substrate of a touch sensor, configured in accordance with some embodiments;

FIGS. 2c and 2d show partial magnified views of a reflective array, configured in accordance with some embodiments;

FIGS. 3a and 3b show a partial back views of an example substrate of a touch sensor, configured in accordance with some embodiments;

FIG. 4 shows a partial back view of an example substrate including an acoustically benign layer, configured in accordance with some embodiments;

FIG. 5 shows a simplified cross-sectional view of a touch sensor device, configured in accordance with some embodiments;

FIG. 6 shows an example control system for a touch sensor device, configured in accordance with some embodiments;

FIG. 7 shows an example of a method for determining coordinate of a touch on a sensor, performed in accordance with some embodiments;

FIGS. 8a and 8b, respectively, show front and back views of an example substrate of a touch sensor, configured in accordance with some embodiments;

FIG. 9 shows an example linear function for mapping a relative timing of an attenuation to a coordinate of the sensor, in accordance with some embodiments;

FIG. 10 shows an example non-linear function for mapping a relative timing of an attenuation to a coordinate of the sensor, in accordance with some embodiments;

FIG. 11 shows an example of a method for manufacturing an acoustic touch product, performed in accordance with some embodiments; and

FIG. 12 shows a back view of an example large substrate of a touch sensor, configured in accordance with some embodiments.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In some embodiments, a touch sensor apparatus may be implemented as a touch screen or other type of touch device, such as a touch computer, touch display, signage, or mobile touch device. The touch apparatus may include a touch sensor and an acoustic wave transducer having a piezoelectric element configured to produce a “surface acoustic wave,” which is used herein to mean a Rayleigh-type wave, Love-type wave, or other surface bound acoustic wave that may be attenuated by an object placed in its path.

Rayleigh waves maintain a useful power density at the touch surface because they are bound to the touch surface. A Rayleigh wave has vertical and transverse wave components with substrate particles moving along an elliptical path in a vertical plane including the axis of wave propagation, and wave energy decreasing with increasing depth in the substrate. Bath shear and pressure/tension stresses are associated with Rayleigh waves. Mathematically, Rayleigh waves exist only in semi-infinite media. In realizable substrates of finite thickness, the resulting wave may be more precisely termed a quasi-Rayleigh wave. Here, it is understood that Rayleigh waves exist only in theory, and, therefore, a reference thereto indicates a quasi-Rayleigh wave. For engineering purposes, it is sufficient for the substrate to be 3 or 4 Rayleigh wavelengths in thickness to support Rayleigh wave propagation over distances of interest to touch sensor design.

Love waves are “surface-bound waves” that are guided by one surface of the substrate provided that the substrate is provided with an appropriate depth profile of varying acoustic properties (unlike Rayleigh waves that require no such inhomogeneity). In contrast to Rayleigh waves, particle motion for Love waves is horizontal, in that they are parallel to the touch surface and perpendicular to the direction of propagation. Shear stress is primarily associated with a Love wave.

For purposes of this description, acoustic touch sensors using Rayleigh-type waves are discussed according to some example embodiments. However, it is recognized that other types of surface acoustic waves, including Love waves, may be used in accordance with some embodiments.

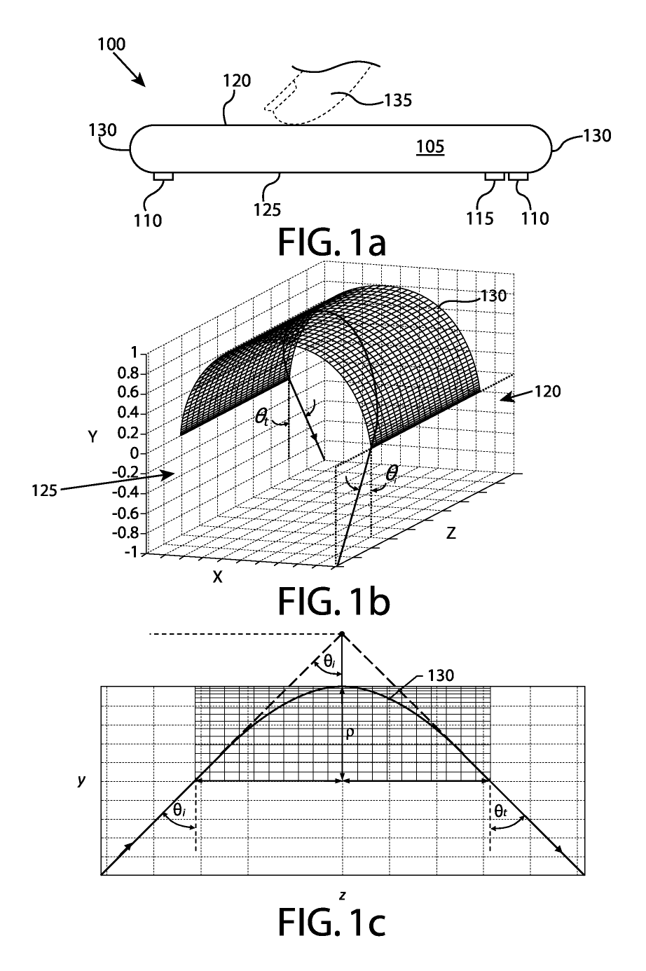

FIG. 1a shows a simplified cross-sectional view of an example touch sensor 100, configured in accordance with some embodiments, but where the thickness (e.g., the height) is exaggerated relative to the length shown. Touch sensor 100 may include substrate 105, acoustic wave transducers 110 (including transducers 110a, 110i, 110c, and 110d discussed below) and reflective arrays 115 (including reflective arrays 115a, 115b, 115c, and 115d discussed below). The substrate of touch sensor 100 is shown as having front surface 120, back surface 125, and connecting surface 130 (including connecting surfaces 130a and 130b discussed below).

Touch sensor 100 may be configured to make use of the fact that surface acoustic waves may propagate around glass or other type of edges, namely connecting surfaces 130, when connecting surfaces 130 are at least relatively smoothly rounded to radii that are at least as large as the surface acoustic waves' wavelength(s). In this case, placing the transmit and receive reflective arrays 115 and transducers 110 on the back of touch sensor 100, e.g., back surface 125 (instead of front surface 120), may be leveraged to create a “bezel-free” or “bezelless” touchscreen.

For example, as shown in FIG. 1b, the radiused edge of connecting surface 130 may be approximated locally as a half-cylinder. This serves a reasonable approximation of some embodiments because the glass edge radius may be much smaller than the side radii of curved profile screens. Further, for purposes of the discussion herein, it is presumed that the glass edges are exactly radiused to the glass half-thickness—that is, the glass edge radius ρ equals half the glass thickness t, or ρ=t/2.

FIG. 1b shows an example of the geometry of a surface acoustic wave ray incident at some angle θₜ on a cylindrical glass edge. The path of the ray may be calculated to determine how it will propagate away from connecting surface 130 to back surface 125 of the glass.

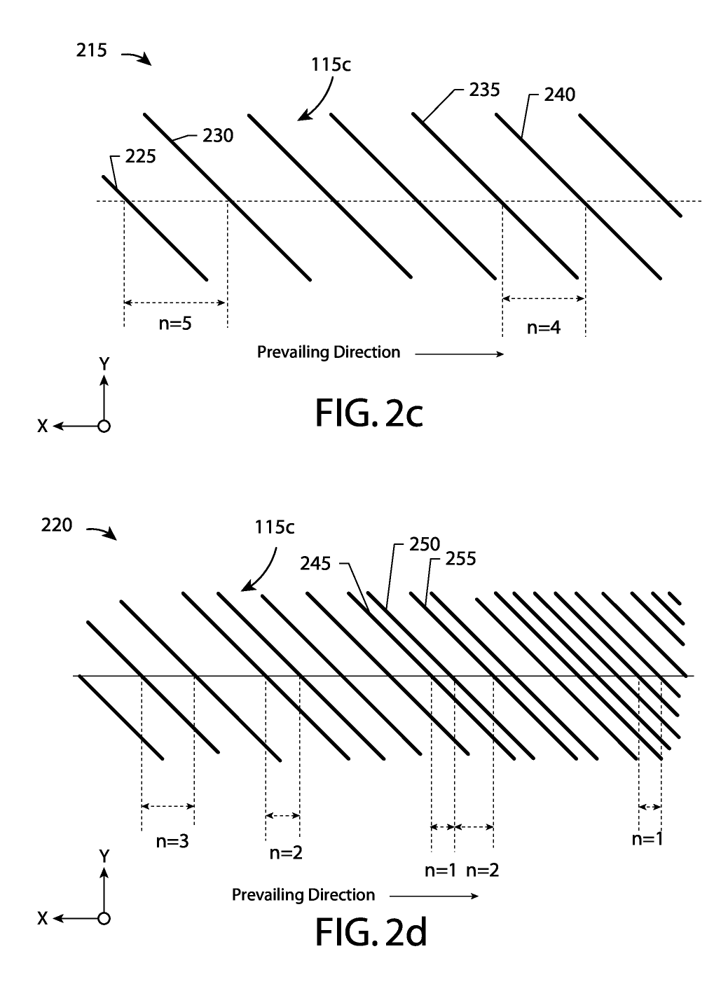

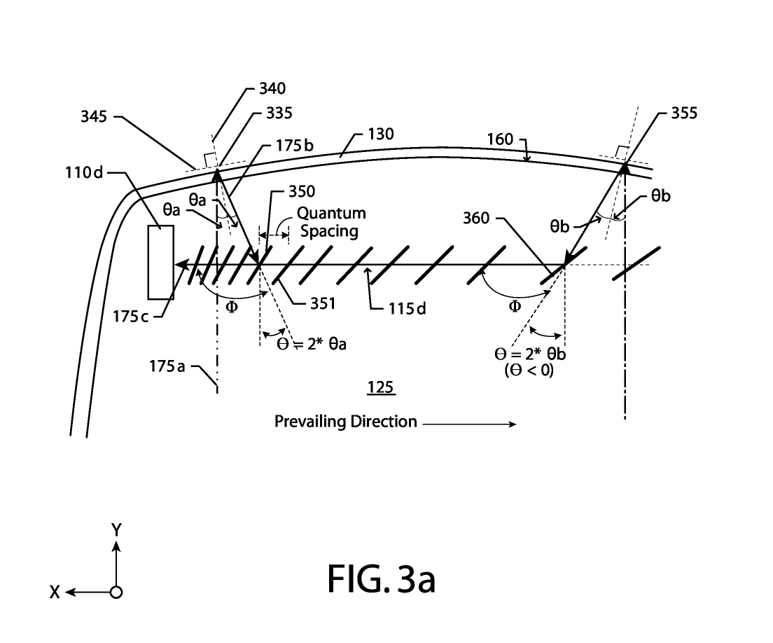

FIG. 1c shows a plan view of the same edge-ray geometry of FIG. 1b (looking from front surface 120 of the glass substrate 105). Note the coordinate system in FIG. 1c is such that the positive Y-axis points up, the positive Z-axis points to the right, and the positive X-axis points down into the plane of the drawing. If the edge radius ρ of connecting surface 130 is large compared to the surface acoustic wave's wavelength, then it may be assumed that there is little anisotropy in the surface acoustic wave phase velocity for different directions of surface acoustic wave propagation over the edge. In many wave propagation problems, waves follow paths of minimum distance (equivalent to Fermat's principle of minimum time). If a cylinder is rolled out flat, the path of minimum distance between any two points is simply the straight line connecting the two points. Rolled back up into a cylinder, these lines become helixes. Hence, for purposes of the discussion herein, it is inferred that waves follow helical paths on cylinders. FIGS. 1b and 1c illustrate such a helical surface acoustic wave ray path. Further discussion of how a wave travels around connecting surface 130 is provided in connection with, e.g., FIGS. 3a, 3b, and 4.

An opaque paint (discussed further below) may then be applied on the rear border of the touch sensor 100 to hide the reflective arrays 115 and transducers 110. For example, surface acoustic waves that are scattered toward the edge by an inverted transmit array may propagate around the at least partially rounded connecting surface 130a, through the active area, around the opposite connecting edge 130b, and received by the receive reflective array (with any attenuations that may have occurred in response to a touch event, such as touch event 135). In some embodiments, connecting surface 130 may be curved as described in commonly-assigned and co-pending U.S. Patent Application Publication No, 2011/0234545 to Tanaka, et al. for “Bezel-less Acoustic Touch Apparatus,” filed Jan. 24, 2011, which is incorporated by reference in its entirety herein and for all purposes.

Touch sensors having a substrate with a rectilinear profile when viewed from the front surface are discussed in commonly-assigned U.S. Pat. No. 5,854,450 to Kent for “Acoustic Condition Sensor Employing a Plurality of Mutually Non-Orthogonal Waves,” which is incorporated by reference in its entirety herein and for all purposes. For example, the front surface and back surface may each define a linear top edge, a linear bottom edge that runs parallel to the linear top edge, a linear left edge and a linear right edge that runs parallel to the linear left edge. The connecting surface joins the front surface and the back surface around the profile of the substrate. As used herein, “profile” refers to the outline of the substrate when viewed from the front or back surface. Thus in the examples incorporated by reference, the front and back surfaces define a rectilinear profile including four linear edges.

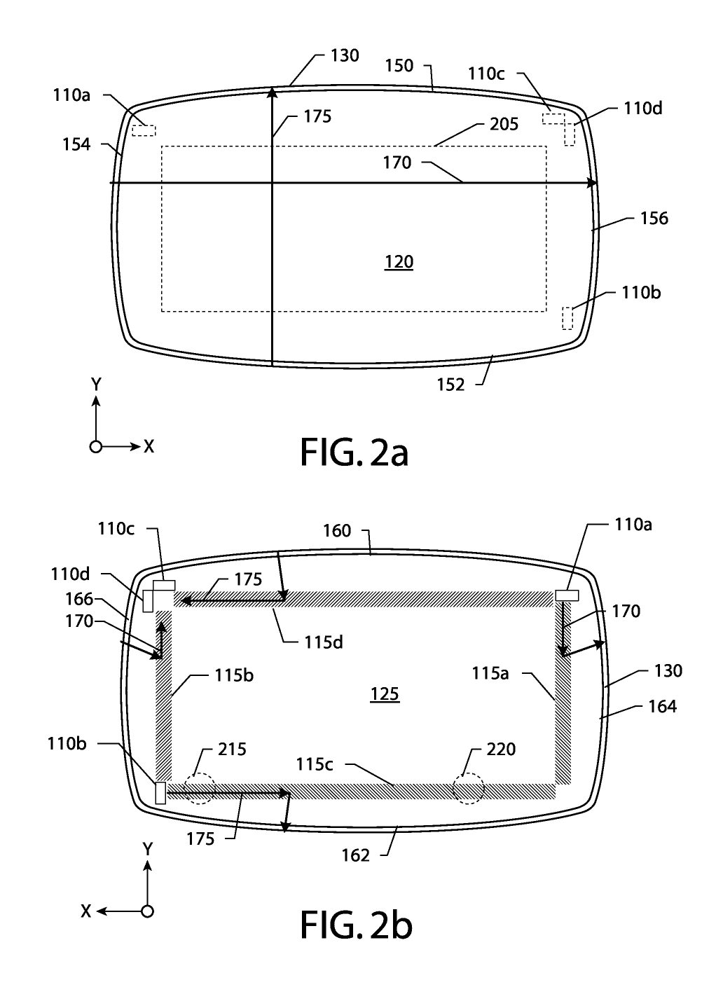

FIGS. 2a and 2b, respectively, show front and back views of touch sensor 100, configured in accordance with some embodiments that have a non-rectilinear profile. More specifically, FIG. 2a shows a plan view of front surface 120 of touch sensor 100 having a bowed profile, and FIG. 2b shows a plan view of back surface 125 of touch sensor 100 having a bowed profile. For example, either or both the top/bottom and left/right sides of the glass in curved profile screens are not parallel—the glass sides are curved in plan view. This curvature of the sides alters the direction of surface acoustic wave rays as they travel around the connecting surfaces 130a, 130b. Consequently, the angles and spacings of reflector elements in the transmit and receive reflective arrays 115 are configured to accommodate the curvature of the profile of substrate 105. Furthermore, the surface acoustic wave path lengths for different surface acoustic wave rays are not equal (as they may be in a rectilinear touch sensor), so timing differences now occur that may be compensated for using a specially programed processor.

Transducers 110 are shown in FIG. 2a as dotted lines to provide a frame of reference in relation to FIG. 2b, which is a plan view of back surface 125 of touch sensor 100 where transducers 110 are shown in solid lines. To provide a further frame of reference, X-Y coordinate axes are shown in FIGS. 2a and 2b.

Front surface 120 may include touch-sensitive region 205 on which an object 135 may create a contact event to provide input according to a user interface shown on a display (not shown in FIG. 1a) disposed behind back surface 125. Touch sensitive region 205 may be defined as an inner portion of front surface 120 that is considered the active touch region. Touch sensitive region 205 is shown within dotted lines in FIG. 2a. Object 135 is shown in FIG. 1a as a finger, but touch events that may be sensed by the touch sensor system may include, e.g., a stylus pressing against front surface 120 directly or indirectly through a cover sheet, an anti-reflective coating, and/or any other suitable material. As shown in FIG. 2a, touch sensitive region 205 may correspond to a transparent area of the touchscreen through which the user can view the display and for which both X and Y coordinates of touches are measured. Nevertheless it is understood that touches on any surface portion of substrate 105 over which surface acoustic wave propagate (including connecting surface 130) will produce signal changes and hence may be sensed. For example, icons may be placed outside of touch sensitive region 205 and still produce a response when touched.

In the example shown in FIG. 2a, front surface 120 of substrate 105 defines four non-linear front edges: top edge 150, bottom edge 152, left edge 154 and right edge 156. Similarly, corresponding back surface 125 of substrate 105, shown in FIG. 2b, defines four corresponding non-linear back edges: top edge 160, bottom edge 162, left edge 164 and right edge 166 (here, “left” and “right” are defined relative to a viewer of the front surface). Front top edge 150 and back top edge 160, when viewed from front surface 120 and back surface 125 respectively, may define mirror image profile edge components. Likewise, front bottom edge 152 and back bottom edge 162, front left edge 154 and back left edge 164, and front right edge 156 and back right edge 166 may also define mirror image profile edge components. As referred to herein, connecting surface 130 joins front surface 120 and back surface 125 between the front and back edges around the profile of substrate 105, such that surface acoustic waves at a given frequency and wavelength may travel from back surface 125 to front surface 120, and vice-versa.

While the non-linear edges in FIGS. 2a and 2b are shown as bowed edges having a convex curvature, one or more edges of substrate 105 may have a concave curvature (not shown to avoid unnecessarily complicating the drawings and disclosure hereof). Furthermore, while four non-linear edges are shown, the substrate may include any combination of one or more linear and non-linear edges. In another example, a non-linear edge may define any type of non-linear profile, such as by including various combinations of concave, convex and/or linear edges and/or edge sections.

In some embodiments, touch sensor 100 may include an opaque portion, a transparent portion, and/or a partially transparent (e.g., “clouded”) portion. When at least one transparent portion and/or substantially transparent portion is included, that portion may be positioned in front of a display device, such that a user viewing front surface 120 may be able to see the display device and its display content through at least a portion of substrate 105, such as touch sensitive region 205. In this regard, touch sensor 100 may be coupled to a control system having a number of functions, including the coordinating of touch functionality with the presentation of displays, some examples of which are discussed below.

Substrate 105 may also be configured to serve as a propagation medium having one or more surfaces on which surface acoustic waves propagate. For example, substrate 105 may be transparent and isotropic. As such, substrate 105 may comprise any suitable glass (e.g., soda lime glass; boron-containing glass, e.g., borosilicate glass; barium-, strontium-, zirconium- or lead-containing glass; crown glass), and/or other suitable material(s). For example, any glass having a relatively low loss of surface acoustic wave propagation, thereby resulting in better signals, may be preferred according to some embodiments.

In some embodiments of touch sensors that are not intended to be used as touch screens (for example, those intended to be used as a peripheral touchpad or integrated trackpad), one or more opaque substrate materials, having acceptable acoustic losses (such as aluminum and/or steel), may be used in touch sensitive region 205. Aluminum and some other metals may be coated with enamel having a relatively slow acoustic phase propagation velocity, thus supporting a Love wave with high touch sensitivity (relative to horizontal shear plate-wave modes) on front surface 120. In some embodiments, substrate 105 may also or instead comprise a low-acoustic-loss polymer, a laminate, and/or other material having inhomogeneous acoustic properties and/or a hole or other absence of material (such as for an integrated microphone or speaker). The laminate, for example, may advantageously support Love wave propagation with acoustic wave energy concentrated on front surface 120 using borosilicate glass or Schott B270™ glass and soda lime glass; or enamel on aluminum.

One or more acoustic wave transducers 110 may be positioned on, or otherwise coupled to, back surface 125 of substrate 105. Various types of transducers may be used in accordance with some embodiments. As referred to herein, a “transducer” includes a physical element or set of elements that transforms energy from one form to another, such as between electrical energy and acoustic energy. For example, transducers 110 may include one or more piezoelectric elements that function as acoustically emissive and/or sensitive structures. As such, any machine that utilizes a transducer discussed herein is configured to transform energy from one form to another.

Transducers 110 may be disposed on back surface 125 for transmitting and/or receiving surface acoustic waves. A “transmitting transducer,” as used herein, refers to at least one of transducers 110 that is configured to transform electrical energy into acoustic energy. For example, a transmitting transducer may include one or more electrodes that are coupled to a controller. The controller may be configured to generate one or more electrical signals, such as pseudo sinusoidal wave tone bursts at one or more desired frequencies. These electrical signals, which are generated by the controller and provided to the transmitting transducer, are sometimes referred to herein as “excitation signals.” The excitations signals may be applied to the electrodes of the transmitting transducer to cause the piezoelectric element therein to vibrate, thereby transforming electrical signals into physical waves having one or more controllable and configurable characteristics (e.g., predetermined resonant frequency, wavelength, etc.).

In some embodiments, the transmitting transducer may further include a wedge shaped coupling block between the piezoelectric element and substrate 105. Vibration of the piezoelectric element may generate bulk waves in the coupling block which in turn couple to the substrate as surface acoustic waves.

A “receiving transducer,” as used herein, refers to at least one of transducers 110 that is configured to transform acoustic energy into electrical energy. A receiving transducer may include, for example, electrodes coupled to the controller, a piezoelectric element, a wedge shaped coupling block, and/or any other suitable component(s). As such, surface acoustic waves traveling through the substrate may cause vibrations in the piezoelectric element (e.g., via the coupling block), which in turn causes an oscillation voltage to appear on the electrodes.

At the receiving transducer, the oscillation voltage on the electrodes may include amplitudes that correspond with amplitudes of return surface acoustic waves received at the receiving transducer. Thus, when perturbations, such as those caused by a touch event, attenuate surface acoustic waves propagating on the substrate between a transmitting transducer and receiving transducer, the attenuation also appears at the electrodes of the receiving transducer in the form of voltage attenuation included in the return electrical signal generated by the receiving transducer and provided to a controller. Controller electronics may be separated from transducers by a length of cable: alternately portions of controller electronics may be located at the transducers, such as a signal power boosting pre-amplifier circuit added to a receive transducer assembly.

One or more reflective arrays 115 may be placed on back surface 125 of substrate 105. Surface acoustic waves may be propagated in a prevailing direction along reflective arrays 115, wherein the beginning and the end of the reflective array is defined by the prevailing direction of the waves' propagation, such that the waves arrive at the beginning of the reflective array first and the end of the reflective array last. Reflective arrays 115 may include a plurality of reflector elements. One or more of the reflector elements may be configured to purposefully function as inefficient reflectors that (1) allow a substantial portion of a surface acoustic wave to pass un-scattered as the wave propagates along the reflective array, and (2) cause the scattering of a relatively small portion of the surface acoustic wave. For example, a desired weak reflector element may be designed to reflect less than 1%, 1.5%, 2% or any suitable amount of the incident surface acoustic wave energy that arrives at the reflector element. Thus, as a surface acoustic wave propagates along the reflective array, some or all of the reflector elements may each scatter (or “reflect” or “direct”) some energy of the surface acoustic wave (the reflected energy is sometimes referred to herein as a “ray” or “redirected” wave), and allow at least some of the energy to pass to the adjacent reflector element in the array. Similarly, the adjacent and/or other subsequent reflector element(s) may reflect some of the acoustic wave's energy and allow at least some of the energy to pass to other reflector elements in the reflective array. In this regard, the surface acoustic wave's energy may be both partially reflected and partially passed until it arrives (e.g., attenuated) at the last reflector element defining the end of the reflective array.

As discussed in greater detail below, reflector elements may scatter the components in controlled directions as a function of the reflector angle of the reflector elements. Thus a reflective array may direct scattered components of a surface acoustic wave generated by a transmitting transducer from back surface 125, across connecting surface 130, and across front surface 120 in the X-axis direction, the Y-axis direction, and/or any other suitable direction(s). A reflective array may also or instead be configured to collect scattered components of a surface acoustic wave that are propagating from front surface 120 (for example, in the direction of the X axis or Y-axis), across connecting surface 130, and towards a receiving transducer on back surface 125.

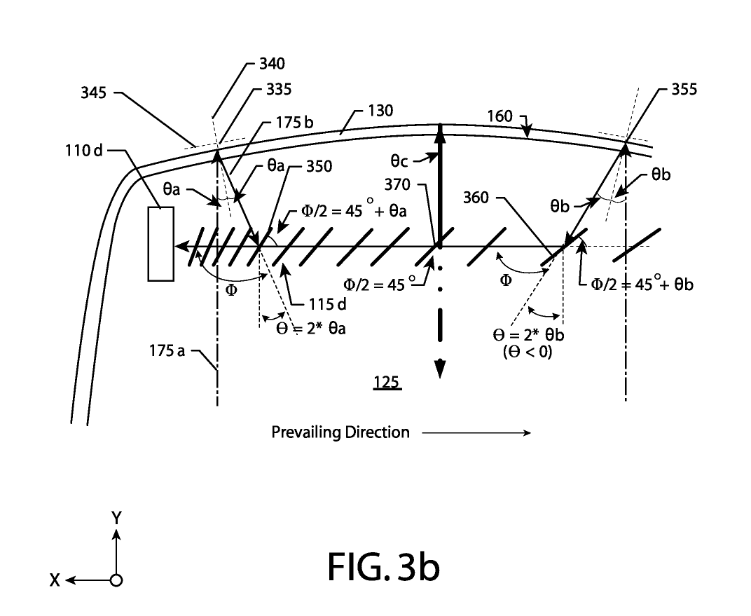

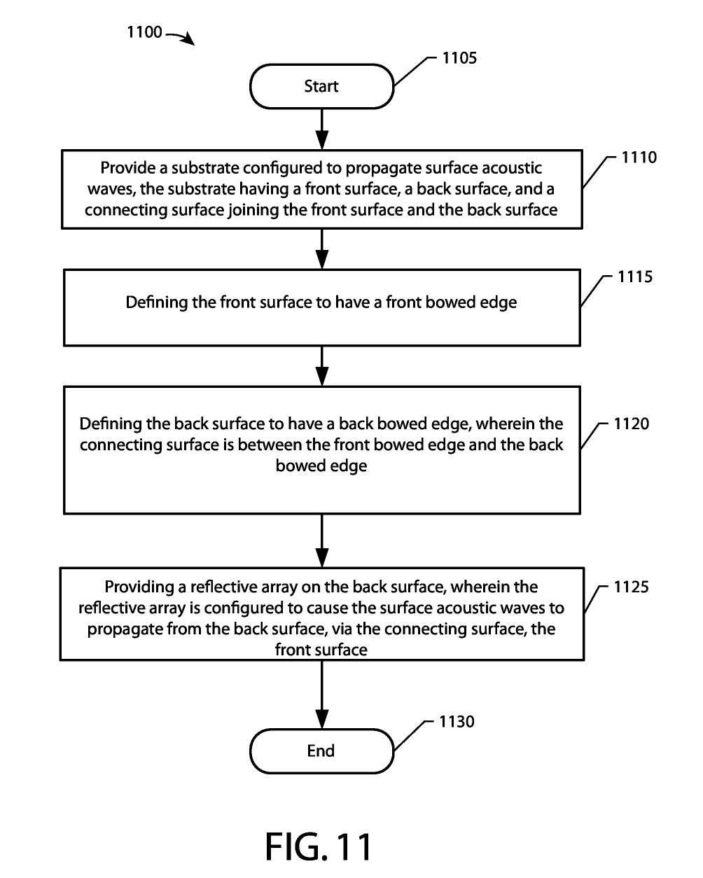

Reflective arrays 115 may be formed in any suitable manner. For example, reflective arrays 115 may be manufactured by printing, etching, stamping a metal substrate, and/or shaping, a mold for a polymer substrate. As another example, reflective arrays 115 may be formed of a glass frit and/or UV curable ink that is silk-screened onto a glass sheet and/or other substrate material, such as formed by a float process, and cured in an oven to form a chevron pattern of raised glass interruptions, which may thereby function as the reflector elements discussed above. Example methods of manufacturing products having reflective arrays are discussed further in connection with FIG. 11. As such, the reflector elements may be configured to have heights and/or depths on the order of 1% of the acoustic wavelength and, therefore, only partially couple and reflect the acoustic wave's energy as discussed above. Because touch sensor 100 may be configured to be positioned in front of a display device, and because reflective arrays 115 are generally optically visible, reflective arrays 115 may be positioned at the periphery of front surface 120 of substrate 105, outside of touch sensitive region 205, where the reflective arrays 115 may be hidden and protected under a bezel. In some embodiments, reflective arrays 115 may be formed on back surface 125 of substrate 105. As shown in FIG. 5, front surface 120 of substrate 105 may have, but does not need, any protective bezel over its periphery.

In some embodiments, touch sensor 100 may include at least two pairs of transducers and reflective arrays, where each pair of transducers and reflective arrays is associated with a sensing axis. For example, the two sensing axes may be orthogonal with respect to each other to form an X-Y coordinate input system. With reference to FIGS. 2a and 2b, two pairs of transducers 110 and reflective allays 115, positioned on back surface 125 of substrate 105, may be associated respectively with the X and Y sensing axes. As shown, transmitting transducer 110a, transmitting reflective array 115a, receiving reflective array 115b, and receiving transducer 110c may be used for determining a Y-coordinate along the Y-axis for a touch event. Similarly, transmitting transducer 110b, transmitting reflective array 115c, receiving reflective array 115d, and receiving transducer 110d may be used for determining an X-coordinate along the X-axis for the touch event.

In some embodiments, such as when touch sensor 100 is configured to provide two orthogonal axes, the two transducer pairs (and transducers 110a, 110c and transducers 110b, 110d) may be disposed at a right angle with respect to each other to define the two sensing axes. Thus, for determining Y-axis coordinates, transmitting transducer 110a may be placed in a Y-axis transmitting area and receiving transducer 110c may be placed in a Y-axis receiving area that is opposite the Y-axis transmitting area along the X-axis. Similarly, for determining X-axis coordinates, transmitting transducer 1101) may be placed in an X-axis transmitting area and receiving transducer 110d may be placed in an X-axis receiving area that is opposite the X-axis transmitting area along the Y-axis.

For example and with reference to FIG. 2b, transmitting transducer 110a may be placed at the top left corner defined by top edge 160 and left edge 164 while receiving transducer 110c may be placed on the top right corner defined by top edge 160 and right edge 166. Transmitting transducer 110b may be placed on the bottom right corner defined by bottom edge 162 and right edge 166 while receiving transducer 110d may be placed on the top right corner defined by top edge 160 and right edge 166. In the example shown, the two transducer pairs are disposed at a right angle, relative to each other, at the top right corner that is defined by top edge 160 and right edge 166.

In some embodiments (not shown), the two transducer pairs may be disposed at a right angle at other corners of substrate 105 to define a coordinate system. Additionally or alternatively, transducers 110 may be configured to transmit and/or receive acoustic waves symmetrically. Thus, the location of a receiving transducer and/or transmitting transducer in a pair (e.g., transducers 110a, 110c or transducers 110b, 110d) may be switched. As another example, one or more of transducers 110 may be configured to function as “transceivers” configured to both transmit and receive surface acoustic waves and perform transformations thereof from/to electrical signals.

Touch sensor 100 may also include a pair of Y-axis reflective arrays 115a and 115b and a pair of X-axis reflective arrays 115c and 115d. As shown in FIG. 2b, reflective arrays 115a and 115c may be configured to act as acoustic wave transmitters, thereby scattering and dissipating surface acoustic waves sent from a transmitting transducer across at least a portion of front surface 120, such as touch sensitive region 205. Reflective arrays 115b and 115d may act as acoustic wave collectors, collecting the scattered surface acoustic waves and directing them to receiving transducers 110c and 110d, respectively.

As shown in FIGS. 2a and 2b, transmitting transducer 110a may be configured to generate and transmit Y-coordinate surface acoustic waves, such as surface acoustic wave 170, in a prevailing direction along reflective array 115a positioned near edge 164 of back surface 125 of substrate 105. For example, the surface acoustic waves may be scattered along the X-axis across front surface 120 of substrate 105 and be used to determine Y-axis coordinate(s) of a touch event. Reflector elements of reflective array 115a may scatter surface acoustic wave 170 as the wave travels from the beginning to the end of reflective array 115a. The scattered components, or rays, of surface acoustic wave 170 may ripple outwardly toward of edge 164, around connecting surface 130 and toward left edge 154. As such, each ray (such as the one shown) of the scattered surface acoustic wave 170 may move generally in the positive X-axis direction (i.e., perpendicular to the sensing Y-axis) as small portions of the wave's energy (e.g., 1% at a time) across front surface 120 toward right edge 156, travel around connecting surface 130, and toward right edge 166, and the rays are merged as a return acoustic wave by reflective array 115b positioned near right edge 166 on back surface 125. Upon traveling to back surface 125, reflector elements of reflective array 115b may direct the scattered, returned surface acoustic wave 70 along reflective array 115b to receiving transducer 110c. Although lines are used in the drawings to represent the prevailing direction of the movement of acoustic waves and rays of acoustic waves, it is understood by those skilled in the art that waves do not always travel as narrow lines and that the use of lines in the drawings is meant to represent the movement of the center of the waveform's travel path while avoiding unnecessarily over complicating the drawings.

Similar to the discussion above regarding Y-coordinate surface acoustic waves, transmitting transducer 1101) may be configured to generate and transmit X-coordinate surface acoustic waves (i.e., surface acoustic waves traveling along the Y-axis on front surface 120 of substrate 105 used for determining X-axis coordinates of a touch event), such as surface acoustic wave 175, in a prevailing direction along reflective array 115c positioned near bottom edge 162 of back surface 125 of substrate 105. Reflector elements of reflective array 115c may scatter surface acoustic wave 175 as rays while the wave travels from the beginning to the end of reflective array 115c. Each of the surface acoustic wave rays of surface acoustic wave 175 may ripple toward bottom edge 162 (such as the one shown), around connecting surface 130 and toward bottom edge 152. As such, a number of rays, each having a small portion of the energy (e.g., 1% of the energy) of surface acoustic wave 175, may move generally in the negative Y-axis direction (i.e., perpendicular to the sensing X-axis) across front surface 120 toward right edge 150, around connecting surface 130, and toward top edge 160 to reflective array 115d positioned near top edge 160 on back surface 125. Upon traveling to back surface 125, reflector elements of reflective array 115d may direct the scattered surface acoustic wave 175 along reflective array 115d to receiving transducer 110d.

When the profile of a substrate edge is non-rectilinear, reflective arrays may be configured to compensate for the non-linear edge(s) and provide an X-Y coordinate system similar to those associated with linear edges. Reflective arrays for linear edges may include a plurality of reflector elements each having a characteristic reflector angle of 45° (plus or minus 1° or some other suitable manufacturing tolerance). When a linear edge is used, each pair of the reflector elements may have a regular spacing. For a reflective array associated with substrates having a non-linear edge (such as the bowed edges shown in FIGS. 2a-5 and FIGS. 8a), the reflector angle of each reflector element and/or the spacing between pairs of reflector elements may vary along the reflective array to adjust for the shape of the non-linear edge(s).

The spacing distance (or “overall” spacing as discussed in greater detail below) between a first reflector element and an adjacent reflector element in the prevailing direction along a reflective array may be determined by:

Overall Spacing=n*Spacing Quantum Equation 1.

where n is a positive integer. The spacing quantum is a function of a surface acoustic wave wavelength to be transmitted from a transducer and will be discussed in further detail below. In this regard the reflective arrays may be tuned to one or more particular wavelengths and the shape of the non-linear edge(s) of a sensor.

In some embodiments, to provide equalized (or more equalized) acoustic power at a receiving transducer over the time duration the return signal is received (e.g., more equalized power for each ray), the value of n in Equation 1 may be decreased with increasing distance from an associated transducer. As such, the overall spacing of the reflector elements of a reflective array may be decreased along the prevailing direction of the array.

FIG. 2c shows an example of a partial magnified view of reflective array 115c at zone 215 (as shown in FIG. 2b). Similarly. FIG. 2d shows an example partial magnified view of reflective array 115c at zone 220 (also shown in FIG. 2b). For clarity, the drawings of FIGS. 2c and 2d neglect the variation in spacing quantum of Equation 1 that is present in typical embodiments so as to illustrate the effect of n on the spacing. Also for illustrative clarity, the drawings of FIGS. 2c and 2d neglect the variation of reflector angles that, as will be explained below, is present in typical embodiments. Reflector elements of a reflective array may have different reflector angles and/or spacing quanta may also vary, as will be described in further detail herein.

As shown in FIG. 2c, reflector element 225 may be disposed 5 spacing quanta (i.e., where n equals 5 in Equation 1) from reflector element 230. Further from the beginning of reflective array 115c along the prevailing direction, reflector element 235 may be disposed 4 spacing quanta from reflector element 240. Even further from the beginning of reflective array 115c, as shown in FIG. 2d, the spacing may further decrease to n=3, 2 or 1 spacing quanta/quantum.

The coherence requirement that center-to-center reflector spacing must be an integer number of spacing quanta limits the freedom to adjust reflector spacing for signal equalization purposes. Nevertheless, for engineering purposes, it remains possible to equalize signals to a good approximation. In some embodiments, for signal equalization purposes, a forbidden spacing of a non-integer number of spacing quantum would otherwise be desired for the spacing in Equation 1 (e.g., spacing=1.5*Spacing Quantum). To achieve a similar effect for signal equalization purposes, the reflective array may be designed to alternate between two or more n integers around a non-integer value. For example, reflector element 245 may be disposed 1 spacing quantum from reflector element 250 while reflector element 255 may be disposed 2 spacing quanta from reflector element 250, which may provide an effect of 1.5 spacing quanta. As such, it is appreciated that the overall spacing between adjacent reflector elements may generally decrease in the prevailing direction for power equalization purposes even as some n values may increase along the prevailing direction.

In some embodiments, the n value in Equation 1 may be kept constant for each element of the reflective array while the balance of acoustic transmissivity and reflectivity of the reflector elements may be altered, allowing increased reflectivity with increasing distance from the transmitting transducer. For example, a reflector element at the beginning of the reflective array may be configured to transmit more, and reflect less, of incident acoustic wave energy. In some embodiments, a combination of varying n values and varying reflector element transmissivity and reflectivity balance may be used to reach desired signal equalization.

The spacing quantum of Equation 1 will now be described with respect to FIG. 3a. In FIG. 3a, the variation of spacing quantum is exaggerated for clarity. Furthermore, the n value is kept constant (e.g., n=1 in Equation 1) in FIG. 3a, in accordance with some embodiments, to illustrate the effect of the spacing quantum on the overall spacing. For array designs with n=1, signal equalization may be accomplished by varying the strength of the reflectors such as increasing line-width or the height of deposited material with increasing distance from the transducer, in some embodiments, however, the n value may vary as described above. As such, both the in value and the spacing quantum may simultaneously contribute to the overall spacing given by Equation 1. Similar comments apply to FIG. 3b and FIG. 4.

FIG. 3a shows example spacing quantum distances between adjacent pairs of reflector elements along a reflective array for a convex bowed edge, configured in accordance with some embodiments. While FIG. 3a shows an example reflective array 115d on back surface 125 of substrate 105 and an associated convex top edge (defined by top edge 160 of back surface 125 and top edge 150 of front surface 120), the techniques discussed herein may apply equally to any type of reflective array and associated convex edge, such as reflective array 115a and associated left edge (defined by left edge 164 of back surface 125 and left edge 154 of from surface 120), reflective array 115c and associated bottom edge (defined by bottom edge 162 of back surface 120 and bottom edge 152 of front surface 120), and reflective array reflective array 115b and associated right edge (defined by right edge 166 of back surface 125 and right edge 156 of front surface 120) shown in FIGS. 2a and 2b.

A beginning of reflective array 115d may be defined as the portion of reflective array 115d closest to receiving transducer 110d. An end of reflective array 115d may be defined as a second portion of reflective array 115d furthest from receiving transducer 115d. As shown, the spacing quantum distances between adjacent pairs of reflector elements may become larger relative to the prevailing direction from the beginning of reflective may 115d to the end of reflective array 115d.

Reflector elements of reflective array 115d may be configured to scatter portions of a surface acoustic wave incident on the reflector elements in the positive X-axis direction along reflective array 115d toward receiving transducer 110d. For example, reflector element 350 may be configured to direct ray 175b of surface acoustic wave 175 in the direction of ray 175c along reflective array 115d. As such, reflector element 350 has a wave scattering angle Φ, defined as the angle between the propagation direction of a surface acoustic wave before being scattered by reflector element 350 (e.g., ray 175b) and the propagation direction after being scattered by reflector element 350 (e.g., ray 175c).

The spacing quantum, as used in Equation 1 given above, between a first reflector element (e.g., reflector element 350) and an adjacent reflector element (e.g., reflector element 351) in the prevailing direction of surface acoustic waves traversing along reflective array 115d may be given by:

Spacing Quantum=½*λ(sin²(Φ/2)) Equation 2,

where λ is the surface acoustic wave wavelength (within the array) and Φ is the wave scattering angle of the reflector element.

Wave scattering angle Φ may depend upon the curvature of the associated edge (which is convex in the example shown) and may be given by:

Wave Scattering Angle Φ=90°+θ Equation 3,

where angle θ is the angle formed between ray 175a and ray 175b as caused by the propagation of surface acoustic wave 175 around the curvature of the top bowed edge at and/or near point 335. More specifically, an angle θa may be formed at point 335 by ray 175a and line 340. Line 340 is a line that is perpendicular to line 345, which is the line that runs tangent to the bowed top edge at point 335. Angle θa is also the angle formed at point 335 by ray 175b and line 340. As such (e.g., in the case that the SAW velocity is the same on front surface 120 and back surface 125), angle θ may be defined as:

Angle θ2*θa Equation 4.

Applying Equations 3 and 4 to Equation 2, the spacing quantum between pairs of reflector elements becomes larger relative to the prevailing direction from the beginning of reflective array 115d near transducer 110d to the end of reflective array 115d further from transducer 110d. At the opposite end of the bowed top edge, such as at point 355, the spacing quantum between reflectors is likewise represented by Equations 2, 3 and 4, except that angle θa is replaced by angle θb. Because angle θb is a negative value, angle θ=2*θb (Equation 4) is also a negative value. As such, wave scattering angle Φ is less than 90°. Applying this wave scattering angle Φ to Equation 2, the spacing quantum between the spacing between pairs of reflector elements continues to become larger relative to the prevailing direction from the beginning of the reflective array 115d to the end of reflective array 115d.

As discussed above, the reflector angle of each reflector element may also vary along the reflective array to adjust for the shape of the non-linear edge(s). FIG. 3b shows example reflector angles along a reflective array for a convex bowed edge, configured in accordance with some embodiments. More specifically, FIG. 3b shows reflector angles for reflective array 115d, also shown in FIGS. 2a, 2b and 3a.

As shown, the reflector angle of a reflector element may be defined as an angle formed between the reflector element and the prevailing direction along the reflective array. The reflector angle of a reflector element (e.g., reflector element 350) may be given by:

Reflector Angle=Φ/2=45°+θa Equation 5.

Applying Equation 5, reflector angles become smaller for successive reflector elements relative to the prevailing direction from the beginning of reflective array I 15d to the end of reflective array 115d. For example, reflector element 350 may have a positive angle θa and thus have a reflector angle greater than 45°. Reflector element 360 may have a negative angle θb and thus has a reflector angle less than 45°, where θb is replaced with θa in Equation 5. Reflector element 370 may have an angle θc equal to 0° and thus has a reflector angle equal to 45°, where θa is replaced with θc=0° in Equation 5.

Additionally or alternatively, as may be the case of concave edges such as discussed in the paragraph below, the reflector angles for reflector elements may become larger relative to the prevailing direction from the beginning of the reflective array 115d to the end of the reflective array 115d.

Similar techniques may be used to construct reflective arrays associated with concave, bowed edges (not shown to avoid unnecessarily complicating the drawings). In such embodiments, the same equations discussed above may apply. However, the concave curvature of the bowed edges causes surface acoustic waves traveling around the connecting surface to each be directed at an angle θa that has an opposite sign in relation to its convex curvature counterpart (relative to distance from the transducer). As such, the spacing quantum between pairs of reflector elements may become smaller relative to the prevailing direction from the beginning of the reflective array to the end of the reflective array and the reflector angles of reflector elements may become larger relative to the prevailing direction. Following similar principles, glass substrates with various combinations of convex and concave edges may also be supported.

It is appreciated that for a reflective array, spacing Equation 1 and reflector angle Equation 5 depend on the curvature of the edge associated with the reflective array, but does not depend on whether the reflective array is associated with a transmitting transducer (e.g., a transmit reflective array such as reflective arrays 115a and 115c shown in FIG. 2b) or a receiving transducer (e.g., a collector reflective array such as reflective arrays 115b and 115d shown in FIG. 2b). In some embodiments, an acoustic wave transducer (such as transducers 110 discussed above) may be configured to behave as a receiving and/or transmitting transducer at the control of the controller with no modification to the reflective arrays. Thus, a receiving transducer may be swapped with a transmitting transducer, or vice versa, without any changes to the associated reflective array.

For example, when receiving transducer 110d is replaced or configured to operate as a transmitting transducer, the spacing quantum between pairs of reflector elements become larger relative to the prevailing direction and the reflector angles become smaller relative to the prevailing direction. As discussed above, the prevailing direction is determined by the distance from an associated transducer, and thus does not change regardless of whether the transducer is a transmitting or receiving transducer.

Returning to Equation 1, the spacing between adjacent reflector elements is shown as as function of n and the spacing quantum. As discussed above, for a reflective array associated with a concave edge, n may decrease in the prevailing direction while the spacing quantum may also decrease. Also as discussed above, however, for a reflective array associated with a convex edge, n may decrease in the prevailing direction while the spacing quantum may increase. In this case, the overall spacing given by Equation 1 may decrease as n values become smaller in the prevailing direction despite the fact that the spacing quantum may actually increase. In other words, adjustments to the overall spacing given by Equation 1 from the spacing quantum may have an overall lesser effect on reflector element spacing than adjustments from changing n values.

As shown in FIG. 5, transducers 110 and reflective arrays 115 may be coupled via an acoustically benign layer 505 to back surface 125, as shown in FIG. 5. For purposes of this description, an “acoustically benign” material is one that allows propagation of surface acoustic waves without rapid attenuation, e.g. increases attenuation by no more than 0.1 dB/cm, preferably resulting in only small changes, such as less than 2%, to the surface acoustic wave's velocity for easier manufacturing control of the wave's velocity despite fractional changes, such as ±25%, in material layer thickness. According to some embodiments, layer 505 may be opaque and be configured to both bond with substrate 105 and serve as an adequate processing surface for transducers 110 and reflective arrays 115 formed thereon. For example, transducers 110 may be bonded on and reflective arrays 115 may be formed with frits on layer 505. In some embodiments, layer 505 may be a thin film of black inorganic material (such as an ink and/or a paint that is screen printed, sputtered, and/or or otherwise applied) on back surface 125 of substrate 105.

In some embodiments, layer 505 may be an inorganic black paint made of ceramic resin or porcelain enamel types of material. Examples of materials may include titanium dioxide (TiO₂) or silica (SiO₂) that may be combined in some embodiments with cobalt (Co), chromium (Cr), copper (Cu), nickel (Ni) or manganese (Mn) for rich colors. Certain high heat resistant paint formulas, such as RustOleum™ high heat ultrapaint or Ferro™ glass coating 24-8328 Black, as well as similar products from other vendors, may be suitable for use as the acoustically benign layer. In other embodiments, the layer may be white and/or other colors.

Additionally or alternatively, layer 505 may provide an appealing and/or vibrant visual appearance, while hiding transducers 35 and reflective arrays 40 from view through substrate 5. Layer 505 may also have a composite of colors used in patterns, other decorative features, and/or useful features such as to indicate edge sensitive touch function inputs according to specific embodiments of the invention. In some embodiments, layer 505 may be translucent, so that light sources such as light emitting diodes) may be disposed behind back surface 125 to shine through translucent layer 505 when activated.

In some embodiments, concealing transducers 110 and reflective arrays 115 may not be desired when, for example, a more industrial or technical appearance is sought, in which case layer 505 may be transparent, not used at all (such as shown in FIG. 1a), or only used on a portion of the periphery of back surface 125.

In some embodiments, layer 505 may be applied across each edge along the periphery of back surface 125 of substrate 105 and disposed between back surface 125 and transducers 110 and reflective arrays 115. For example, layer 505 may be visible through substrate 105 (and in embodiments where layer 505 is opaque, shield transducers 110 and reflective arrays 115 from view) and thus appears to frame touch sensitive region 205 shown in FIG. 2a to a viewer of front surface 120.

The thickness of layer 505 may be configured such that any signal attenuation resulting from layer 505 is balanced with any cosmetic objectives relating to the opacity. Layer 505 may have an effect on the wave velocity of surface acoustic waves traveling in the region of layer 505, because the coating thickness of layer 505 may alter how surface acoustic waves propagate.

The equations for the spacing between reflector elements and the reflector angle of each reflector element in a reflective array may be modified to account for the altered wave velocity. With reference to FIG. 4, a ray 180a of a surface acoustic wave propagates across bare substrate front side 120 along the positive Y-axis direction, around connecting surface 130 at point 405 at a wave velocity V_{SAW}. The surface acoustic wave then propagates from point 405 across a region of back surface 125, including layer 505 (represented in FIG. 4 by light grey lines) at a wave phase velocity V′_{SAW}, as shown by ray 180b. Angle θg is the angle formed between ray 180a and line 410, which is perpendicular to line 415 that runs tangent to the bowed top edge at point 405.

Angle θ′g is the angle formed between ray 180b and line 410, which may be determined, when angle θg. V_{SAW} and V′_{SAW} are known by:

$${θ}^{′} g = arcsin ( {V}_{SAW}^{′} * \frac{sin ( θ g )}{{V}_{SAW}} ) . \qquad Equation 6$$

The spacing quantum between a reflector element, such as reflector element 420, and the next reflector element, such as reflector element 425, in the prevailing direction of surface acoustic wave propagation along a reflective array, may be determined by Equation 2, where λ is the surface acoustic wave wavelength within the reflective array including the effects of layer 505 as well as velocity loading effects of the reflective array. However, wave scattering angle Φ may now be given by:

Wave Scattering Angle Φ=90°+θg+θ′ Equation 7

The reflector angle of reflector element 420 may be determined by:

Reflector Angle=Φ/2=45°+(θg+θ′g)/2 Equation 8.

The above questions provide useful tools for design of reflector arrays in touch sensors of various embodiments of the invention. In some cases, to more fully account for higher order effects and/or reproducible deviations between manufactured product and nominal design, iterative fine tuning of reflector spacings and angles may be desired to more fully optimize array performance. For example, a practical engineer may prefer iterative fine tuning over first-principle calculations that fully and precisely account for all subtle effects such as velocity loading effects.

FIG. 5 shows a simplified cross-sectional view of an example touch sensor device 500, which may be a touch monitor, a touch computer, a touch video display, a touch mobile device, and/or any other suitable machine having touch-input functionality. Touch device 500 may include substrate 105, acoustically benign layer 505, transducers 110, reflective arrays 115, display device 510, touch controller 515 and housing 520, among other things.

Display device 510 may be, for example, a liquid crystal display (LCD), organic light emitting device (OLED) display, electrophoretic display (EPD), vacuum fluorescent, cathode ray tube, and/or any other display component. In some embodiments, display device 510 may provide a graphical user interface compatible with touch inputs. Display device 510 may be positioned such that it is visible through substrate 105, thereby enabling a person viewing front surface 120 of substrate 105 to see display device 510 through substrate 105. In some embodiments, display device 510 may be optically bonded to back surface 125. For example, display device 510 may be bonded to back surface 125 via layer 505 and mounting tape 525. In other embodiments display device 510 does not contact back surface 125 and is disposed behind substrate 105 (e.g., held stable by housing 520 and/or an adhesive, such as mounting tape).

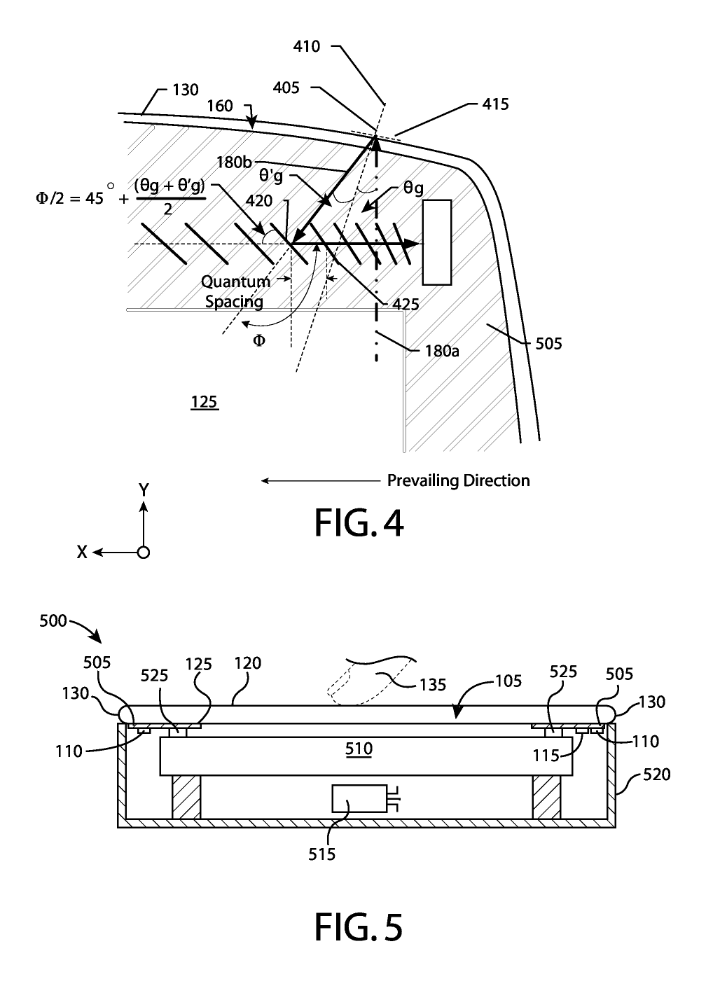

Touch controller 515 may be configured to control transducers 110 and to determine touch coordinates. The operation of touch controller 515 is discussed further below with respect to FIGS. 6-9.

Housing 520 may contain and protect display device 510, layer 505, transducers 110, reflective arrays 115, touch controller 515, as well as other components of the device that are not shown to avoid unnecessarily overcomplicating the drawings. In some embodiments, one or more of the components of touch device 500 may be attached via housing 520.

FIG. 6 shows a block diagram of an example control system 600 for a touch sensor device, configured in accordance with some embodiments. Control system 600 may include touch controller 515, main controller 605, transducers 110 and display device 510.

Touch controller 515 may include one or more processors 515a configured to execute firmware or software programs stored in one or more memory devices 515b to perform the functionality described herein. Touch controller 515 may be coupled via wires, leads, and/or by any other suitable manner to transducers 110 to control the transmission and reception of surface acoustic waves, such as those discussed above.

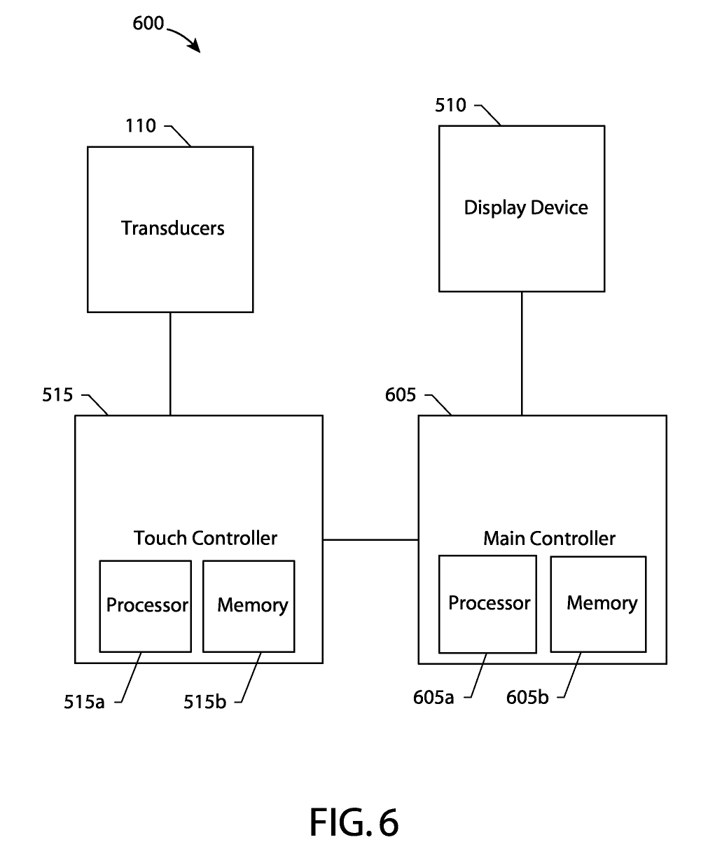

Touch controller 515 may further be configured to determine touch coordinates on the touch region based on the timing of an attenuation received at a receiving transducer, such as receiving transducer 110c or receiving transducer 110d discussed above. As will be discussed in further detail below with respect to FIG. 7, touch controller 515 may be further configured to adjust for propagation time differences between rays of a surface acoustic wave caused by non-rectilinear substrate edges.

In some embodiments, touch controller 515 may interface with a computer system, such as a personal computer, embedded system, kiosk, user terminal, and/or other machine as a human-to-machine interface device. The computer system may include main controller 605 with one or more processors 605a configured to execute firmware or software programs stored in one or more memory devices 605b. Via the execution of the programs, main controller 605 may generate a visual component (and/or display element) that is sent to display device 510 for display. The visual component may include or comprise a user interface that is operable using the touch sensor.

The computing system may further include other display devices, audio input and/or output capability, keyboard, electronic camera, other pointing input device, or the like (not shown). The computer system may operate using custom software, but more typically may use a standard and/or other type of operating system. In examples were the computing system is configured to enable use of other user input devices, the touch sensor may be employed as a primary or secondary input device.

Main controller 605 may be communicatively connected with touch controller 515. In some embodiments, touch coordinates and/or position information may be sent from touch controller 515 to main controller 605, allowing a user to interact with a program executing on main controller 605 via the touch sensor. In some embodiments, touch controller 515 may be further configured to map the touch coordinates to appropriate control actions that are sent to main controller 605. For example, a multi-dimensional dataset (such as a two dimensional table) may be used to associate timing information of a surface acoustic wave attenuation with one or more coordinates representing a physical location of the sensor. The data stored in the map may be based on the non-linear edge of the sensor.

While FIG. 6 shows touch controller 515 as a separate device from main controller 605, a single controller may be configured to perform all of the functions described herein. For example, touch controller 515 and main controller 605 may be integrated in an embedded system in some embodiments.

In some embodiments, each processing/controlling component (e.g., processor 515a and/or processor 605a) of control system 600 may be embodied as, for example, circuitry or other type of hardware elements (e.g., a suitably programmed processor, combinational logic circuit, and/or the like). The processing/controlling components may be configured by a computer program product comprising computer-readable program instructions stored on a non-transitory computer-readable medium (e.g., memory 515b and/or memory 605b) that is executable by a suitably configured processing device (e,g., processor 515a and/or processor 605a), or some combination thereof.

Processor 515 and/or processor 605a may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 6 as single processors, processor 515a and/or processor 605a may comprise a plurality of processors in some embodiments. The plurality of processors may be embodied on a single computing device or may be distributed across a plurality of computing devices collectively configured to function as a processing module of control system 600. The plurality of processors may be in operative communication with each other and may be collectively configured to perform one or more functionalities of control system 600 as described herein.

Whether configured by hardware, firmware/software methods, or by a combination thereof, processor 515a and/or processor 605a may comprise an entity capable of performing operations according to various embodiments while configured accordingly. Thus, for example, when processor 515a and/or processor 605a are embodied as an ASIC, FPGA or the like, processor 515a and/or processor 605a may comprise specifically configured hardware for conducting one or more operations described herein. Alternatively, as another example, when processor 515a and/or processor 605a are embodied as an executor of instructions, such as may be stored in memory 515b and/or memory 605b, the instructions may specifically configure processor 515a and/or processor 605a to perform one or more algorithms and operations described herein, such as those discussed below in connection with FIG. 7.

Memory 515b and/or memory 605b may comprise, for example, volatile memory, non-volatile memory, or some combination thereof. Although illustrated in FIG. 6 as single memory components, memory 515b and/or memory 605b may comprise a plurality of memory components. The plurality of memory components may be embodied on a single computing device or distributed across a plurality of computing devices. In various embodiments, memory 515b and/or memory 605b may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 515b and/or memory 605b may be configured to store information, data, applications, instructions, or the like for enabling control system 600 to carry out various functions in accordance with some embodiments. For example, in at least some embodiments, memory 515b and/or memory 605b may be configured to buffer input data for processing by processor 515a and/or processor 605a. Additionally or alternatively, in at least some embodiments, memory 515b and/or memory 605b may be configured to store program instructions for execution by processor 515a and/or processor 605a. Memory 515b and/or memory 605b may store information in the form of static and/or dynamic information. This stored information may be stored and/or used by control system 600 during the course of performing its functionalities.

Embodiments have been described above with reference to a block diagram of circuitry. Below is a discussion of an example process flowchart describing functionality that may be implemented by one or more components of circuitry, such as those discussed above in connection with control system 600 in combination with touch sensor 100. Each block of the circuit diagrams and process flowcharts, and combinations of blocks in the circuit diagrams and process flowcharts, respectively, may be implemented by various moans including computer program instructions. These computer program instructions may be loaded onto a general purpose computer, special purpose computer, or other programmable data processing apparatus, such as processor 515a or processor 605a discussed above with reference to FIG. 6, to produce a machine, such that the computer program product includes the instructions which execute on the computer or other programmable data processing apparatus create a means for implementing the functions specified in the flowchart block or blocks.

These computer program instructions may also be stored in a computer-readable storage device (e.g., memory 515b and/or memory 605b) that may direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, may be implemented by special purpose hardware-based computer systems that perform the specified functions or steps, or combinations of special purpose hardware and computer instructions.

FIG. 7 shows an example of a method 700 for determining a coordinate of a touch event on a sensor, performed in accordance with some embodiments. The coordinate of the touch even may at least partially represent a physical location on the sensor where the touch event occurred. For instance, the coordinate of the touch event may be along a sensing axis, such as the X-axis or Y-axis. Thus the coordinate of touch may determine a physical location on the sensor along the X-axis or the Y-axis.

While method 700 is described in detail where the coordinate of the touch is along the Y-axis (i.e., to determine Y-axis touch coordinates), a similar technique may be used where the sensing axis is the X-axis. Thus a coordinate pair may be determined by repeating and/or alternating method 700 for both the X and Y sensing axes, or more generally, any set of orthogonal or otherwise-situated sensing axes.

In some embodiments, method 700 may be performed by the example structures shown in FIGS. 1-6 and 8. For instance, circuitry such as touch controller 515 or main controller 605 may be configured to perform method 700. For clarity, method 700 may be described with reference to elements shown in these figures. It will be appreciated, however, that other structures may be used to perform method 700 in other embodiments.

Method 700 may start at 705 and proceed to 710, where circuitry may generate an electrical excitation signal. For example, circuitry such as touch controller 515 or main controller 605 may be configured to generate the excitation signal. In some embodiments, the excitation signal may be a sinusoidal wave or a pseudo sinusoidal wave tone burst at a desired frequency.

At 715, the circuitry may transmit the electrical excitation signal to a transmitting transducer that is configured to transform the electrical excitation signal into at least one acoustic wave. As discussed above, the transmitting transducer (such as transducer 110a, 110b discussed above) may include electrodes connected with the circuitry, a piezoelectric element, and a coupling block in some embodiments. The electrical excitation signal may be applied by the circuitry to the electrodes to cause a piezoelectric element in the transmitting transducer to vibrate. Vibration of the piezoelectric clement may generate bulk waves in the coupling block which in turn couple to the substrate as surface acoustic waves.

At 720, the circuitry may receive an electrical return signal from a receiving transducer that is configured to transform the acoustic wave into the electrical return signal. Also as discussed above, the receiving transducer (such as transducer 110c, 110d) may include electrodes connected with the circuitry, a piezoelectric element, and a coupling block in some embodiments. Acoustic waves coupled to the substrate may cause vibrations in the piezoelectric element via the coupling block, which in turn causes an oscillation voltage to appear on the electrodes. The circuitry may receive the electrical return signal via the electrodes.

The electrical return signal may represent the acoustic wave subsequent to its propagation through, the sensor. Thus, an attenuation in the acoustic wave, as may be caused by a touch event that occurred while the acoustic wave propagated through the sensor, may cause a corresponding attenuation in the electrical returned signal.

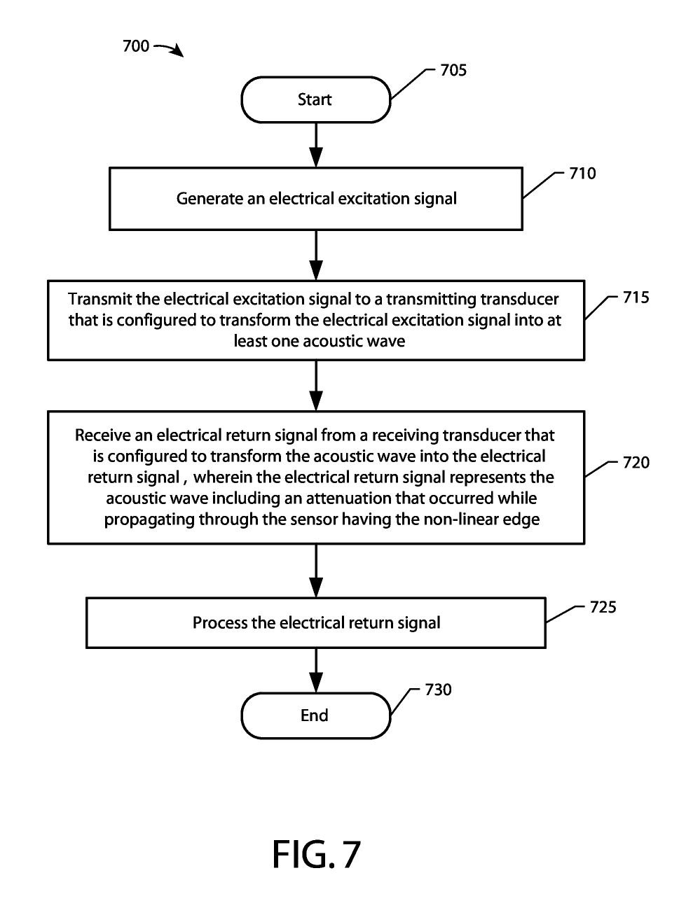

FIGS. 8a and 8b show an example of multi-ray propagation paths of an acoustic wave through an example sensor. In some embodiments, transmitting transducer 110a may transmit acoustic wave 805 in a prevailing direction along reflective array 115a. Reflector elements of reflective array 115a may scatter the acoustic wave transmitted along reflective array 115a into rays 810 that propagate from back surface 125 of substrate 105, around a first edge (e.g., the left edge defined by left edge 164 of back surface 125 and left edge 154 of front surface 120), across the front surface 120 in a prevailing direction that is perpendicular to the sensing axis, and around a second edge (e.g., the right edge defined by right edge 156 of front surface 120 and right edge 166 of back surface 125) of the substrate opposite the first edge to back surface 120. The reflector elements of reflective array 115b may then direct rays 810 of acoustic wave 805 in a prevailing direction along reflective array 115b to receiving transducer 110c. Receiving transducer 110c may then transform acoustic wave 805 into the electrical return signal.

In some embodiments, the acoustic wave may traverse the sensor from the transmitting transducer to the receiving transducer via a non-linear edge of the sensor. As shown in FIGS. 8a and 8b, rays 810 of acoustic wave 805 traverse around a bowed left edge. Rays 810 also traverse around a bowed right edge. While FIGS. 8a and 8b show rays 810 traversing around two non-linear edges between transmitting transducer 110a and receiving transducer 110c, rays 810 may traverse around a single non-linear edge and a linear edge) or no non-linear edges (e.g., two linear edges or no edges when placed on the front of the sensor's substrate) in some embodiments that are not shown. The spacing between adjacent pairs of reflector elements as well as the reflector angle of each reflector element in a reflective array may be configured based on whether an associated edge is linear or non-linear as described above.

As shown in FIG. 8a, rays 810 may also traverse across front surface 120 as acoustic wave 805 propagates between transmitting transducer 110a and receiving transducer 110c. As rays 810 propagate across touch region 205 on front surface 120, a touch event within touch region 205 may cause at least one attenuation in acoustic wave 805 that may be received at receiving transmitter 110c. To provide complete coverage within the entire touch region 205, rays 810 may be scattered by reflective array 115a such that rays 810 span at least the sensing axis (e.g., the Y-axis in the example shown in FIGS. 8a) in touch region 205. Put another way, acoustic wave 805 may be directed such that at least some of its acoustic energy propagates along the entire touch region 205 as rays 810. This allows a touch event anywhere within touch region 205 to perturb and attenuate the acoustic wave as it travels across touch region 205. Rays 810 may then be recombined into a return acoustic wave by reflective array 115b.

Returning to FIG. 7, at 725, the circuitry may process the electrical return signal received at 720. Processing the electric return signal may be performed to determine a coordinate of a touch event on the sensor in touch region 205. As discussed above, the coordinate may at least partially represent (i.e., along one sensing axis) a physical location on the sensor where the attenuation occurred. Method 700 may then end at 730.

In some embodiments, processing the electrical return signal may include determining a relative timing of each attenuation included in the return acoustic wave. In such embodiments, the circuitry may determine an actual time for when the transmitting transducer transmits the acoustic wave and actual times for when the receiving transducer receives each ray. The propagation time for each ray may be determined by subtracting the actual time for when the transmitting transducer transmits the acoustic wave from the actual times for when the receiving transducer receives each ray. A relative time for each ray may be determined by subtracting the shortest propagation time of the rays from the propagation time for each ray.

With reference to FIGS. 8a and 8b, rays 810 of acoustic wave 805 may have varying propagation path lengths between transmitting transducer 110a and receiving transducer 110c. When the wave velocity of rays 810 is constant or substantially constant through the sensor, the varying propagation path lengths may result in varying propagation times between transmitting transducer 110a and receiving transducer 110c corresponding with the varying propagation path lengths. As discussed in further detail below, different rays of rays 810 may be associated with different locations along the sensing axis. Thus, an attenuation at a particular time or times in the electrical return signal, corresponding with an attenuation in a least one particular ray, may be mapped or otherwise associated (e.g., mathematically using a time function) to a particular location along the sensing axis where the attenuation occurred.

For example, acoustic wave 805 is scattered into rays 810, which is shown as including ray 815, ray 820, and ray 840. Ray 815 traverses a distance 815a from transmitting transducer 110a along reflective array 115a, a distance 815b from reflective array 115a to connecting surface 130 near left edge 164, a distance 815c across front surface 120, a distance 815d from connecting surface 130 near right edge 166 to reflective array 115b, and a distance 815e along reflective array 115b to receiving transducer 110c.

In comparison, ray 820 of acoustic wave 805 traverses a distance 820a from transmitting transducer 110a along reflective array 115a, a distance 820b from reflective array 115a to connecting surface 130 near left edge 164, a distance 820c across front surface 120, a distance 820d from connecting surface 130 near right edge 166 to reflective array 115b, and a distance 820e along reflective array 115b to receiving transducer 110c.

As shown, the total distance, and thus total propagation time, between transmitting transducer 110a and receiving transducer 110c is shorter for ray 815 than ray 820. Thus an attenuation in ray 815, corresponding with Y-coordinate 825 will be received at receiving transducer at an earlier time than an attenuation in ray 820, corresponding with Y-coordinate 830. As discussed above, the receiving transducer may transform the acoustic wave into the electrical return signal at 720 such that the electrical return signal represents the acoustic wave including the attenuation.

A relative timing for each ray, and associated attenuations, may be determined by subtracting, the propagation time of ray 835 (i.e., the ray with the shortest propagation time as shown in FIG. 8a) from the propagation time of each ray. Thus ray 835 will have a relative timing of 0 microseconds (or any other unit of time), ray 815 will have a relative timing greater than 0 microseconds, and ray 820 will have a relative timing greater than the relative timing of ray 815.

In some embodiments, processing the electrical return signal may further include mapping the relative timing of the attenuation to a coordinate of the sensor. As discussed above, the coordinate may at least partially represent a physical location (e.g., one coordinate along the sensing axis, such as Y-coordinate 825 or Y-coordinate 830 shown in FIG. 8b) on the sensor where an attenuation occurred, which may represent a touch event.

When the acoustic wave does not propagate across a non-linear edge (not shown) between the transmitting transducer and the receiving transducer, the mapping may use a linear function associated with how the acoustic wave is expected to travel relative to time from, the transmitting transducer to the receiving transducer. In such embodiments, each ray may have a different propagation length, and thus a different propagation time, that is determined by the distances of propagation along the two reflective arrays. The remaining path length for each ray between the transmitting transducer and the receiving transducer may be the same distance for each ray. Thus, rays scattered closer to the beginning of a transmit reflective array may have a relatively shorter propagation time from the transmitting transducer to the receiving transducer than a ray scattered further from the beginning of the transmit reflective array.

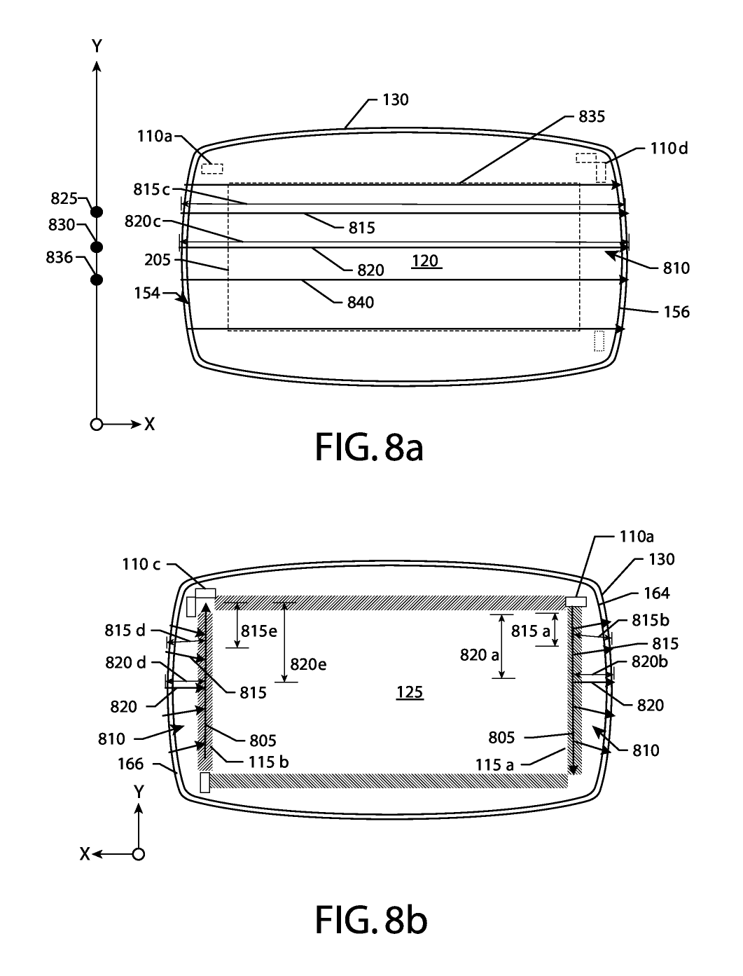

FIG. 9 shows an example plot of linear function 900 fur a Y-coordinate sensing axis. The relative time of a received attenuation is shown on the horizontal axis and the location of a touch event along the Y-axis in the touch region is shown on the vertical axis. As shown, an attenuation received at relative time 0 is associated with a Y-coordinate at the top of the touch region while an attenuation received at a later relative time, shown at 905, is associated with a Y-coordinate at the bottom of the touch region. Between relative time 0 and the later relative time shown at 905, the Y-coordinate value in the touch region decreases linearly in relation to the relative time of a received attenuation.

When the acoustic wave propagates across at least one non-linear edge between the transmitting transducer and the receiving transducer (e.g., acoustic wave 810 shown in FIGS. 8a and 8b propagates across a convex non-linear left edge and a convex non-linear right edge between transmitting transducer 110a and receiving transducer 110c), the mapping may be based on a non-linear function associated with how the acoustic wave is expected to travel relative to time from the transmitting transducer to the receiving transducer. In some embodiments, the map may be pre-computed and/or the actual mapping function may be executed in real or near-real time by one or more processors. Each ray may have a different propagation length, and thus a different propagation time, that is determined by the distances of propagation along the two reflective arrays as well as the distances of propagation across the at least one non-linear edge. Thus, while rays scattered closer to the beginning of a transmit reflective array may have a relatively shorter propagation time from the transmitting transducer to the receiving transducer than a ray scattered further from the beginning of the transmit reflective array, the relationship between the relative time of a received attenuation and a coordinate value of a touch event in the touch region may be non-linear in a manner associated with the sensor's non-linear edge(s).

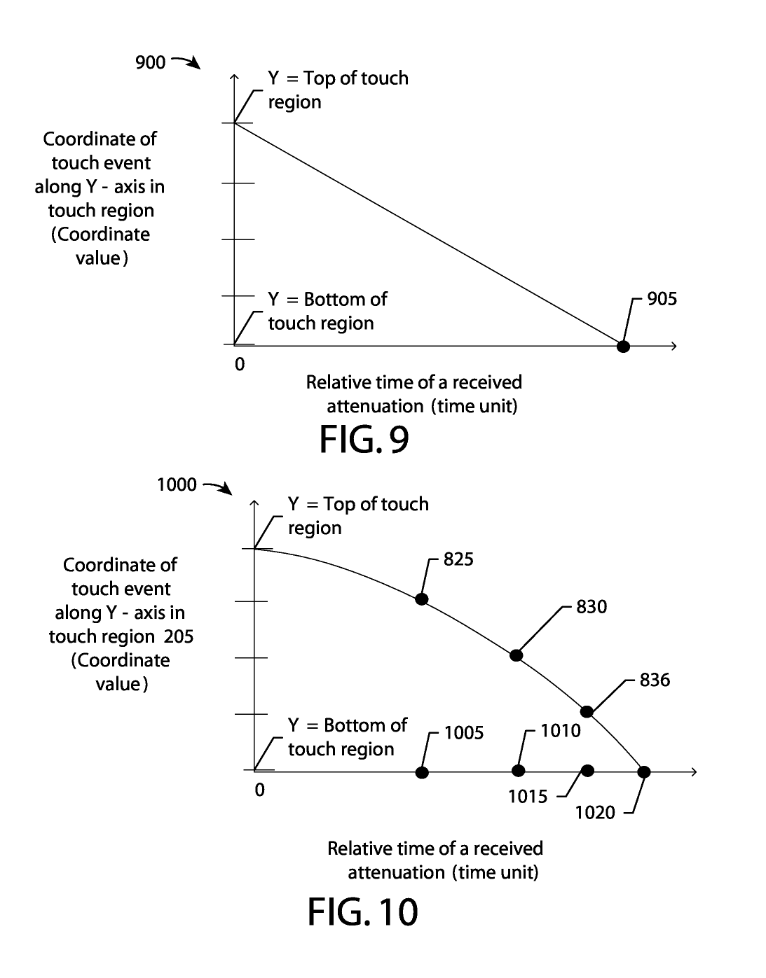

FIG. 10 shows an example plot of non-linear function 1000 for a Y-coordinate sensing axis. The relative time of a received attenuation is shown on the horizontal axis and the location of a touch event along the Y-axis in the touch region is shown on the vertical axis. The non-linear function may be fit to the curvature of the non-linear edge(s), this function 1000 will be described with reference to the left and right edges of the sensor shown in FIGS. 8a and 8b.

As shown, an attenuation received at relative time 0 is associated with a Y-coordinate at the top of the touch region while an attenuation received at a later relative time, shown at 1020, is associated with a Y-coordinate at the bottom of the touch region. Between relative time 0 and the later relative time shown at 1020, the Y-coordinate value in the touch region decreases non-linearly in relation to the relative time of a received attenuation.

For example, Y-coordinate 825 (associated with ray 815c as shown in FIG. 8a) that is one quarter of the total Y-axis length of touch region 205 away from the top of touch region 205, has a relative time of a received attenuation shown at 1005 that is greater than one quarter of the total time between relative time 0 and the later relative time shown at 1020. Y-coordinate 830 (associated with ray 820c as shown in FIG. 8a) that is one half of the total Y-axis length of touch region 205 away from the top of touch region 205, has a relative time of a received attenuation shown at 1010 that is greater than one half of the total time between relative time 0 and the later relative time shown at 1020. Y-coordinate 836 (associated with ray 840 as shown in FIG. 8a) that is three quarters of the total Y-axis length of touch region 205 away from the top of touch region 205, has a relative time of a received attenuation shown at 1015 that is greater than three quarters of the total time between relative time 0 and the later relative time shown at 1020. Comparing the time increments between the relative times shown, it is appreciated that time increments become relatively smaller as the relative time of a received attenuation increases as coordinate increments remain constant along the Y-axis in touch region 205, namely there is a non-linear relationship between the touch coordinate and the relative time of a received attenuation.

In embodiments where the acoustic wave propagates across one or more non-linear concave edges between a transmitting transducer and receiving transducer, a non-linear function may also apply. However, unlike non-linear function 1000 shown in FIG. 10, time increments become relatively larger as the relative time of a received attenuation increases as coordinate increments remain constant.

In some embodiments, as discussed above, the transducers and the reflective arrays may be coupled to the back surface of a sensor via an acoustically benign layer, such as acoustically benign layer 505 shown in FIGS. 4 and 5. In such embodiments, the assumption that rays travel at a constant wave velocity throughout the sensor may not be sufficiently accurate to reliably determine a touch coordinate. Thus, propagation times for each ray may be calculated by summing the individual propagation times that the ray travels through substrate and layer regions between the transmitting transducer and receiving transducer.

A relative timing for each ray, and associated attenuations, may be determined by subtracting the propagation time of the ray with the shortest propagation time from the propagation time of each ray. Next, the relative timing of an attenuation may be mapped to a coordinate of the sensor. When the acoustic wave does not propagate across a non-linear edge between the transmitting transducer and the receiving transducer, the mapping may use a linear function. In other words, the relative timing does not change because each ray travels an equal distance through the layer regions.

When the acoustic wave propagates across at least one non-linear edge between the transmitting transducer and the receiving transducer, the mapping may use a non-linear function. In such embodiments, the non-linear function is fit to the distances of propagation across the at least one non-linear edge for each ray, where different rays may propagate different distances through the acoustically benign layer because of the at least one non-linear edge, as shown for layer 505 in FIG. 5.

In some embodiments, the non-linear or linear function may be stored in memory associated with the circuitry, such as in memory 515b and/or memory 605b shown in FIG. 6. As discussed above, the characteristics of the functions may be determined by physical characteristics of the sensor, such as the curvature profile. Thus prior to or during the manufacture of the sensor, a function fit to the sensor may be determined and stored. In operation, once a relative timing of an attenuation is determined, the relative timing may be mapped to a coordinate of the sensor by referencing the stored function. With reference to FIG. 10, for example, when a relative timing of a received attenuation at 1005 is detected, Y-coordinate 825 may be readily determined by referencing function 1000.

The functions described above may be embodied in any suitable form. In one example, a function may be embodied in software stored in a memory, where the relative timing is the input and the coordinate is the output of the function. In another example, a function may be embedded in hardware, such as specialized circuitry configured to perform the function.

In some embodiments, the circuitry may be further configured to associate the coordinate determined by method 700 with a display element shown on a display device, such as display device 510 shown in FIGS. 5 and 6. The display device may be configured to present the display element while the acoustic wave propagates through the sensor. The display element may be part of a user interface of a program. As such, associating the coordinate with the display element may include determining that a user has indicated a desire to select the display element.

While method 700 and FIGS. 8a-10 have been discussed in connection with a Y-axis touch coordinate, a similar approach may also be used for determining an X-axis touch coordinate. For instance, while method 700 is performed for determining a Y-axis touch coordinate, method 700 may also be performed for determining an X-axis coordinate. The X-axis coordinate may at least partially represent a physical location on the sensor where the attenuation occurred, more specifically, the physical location along the X-axis of the attenuation. The X-axis and Y-axis coordinate may define a coordinate pair of a touch event.

For example, two pairs of transducers may be provided respectively for the X and axes. Thus transmitting transducer 110b and receiving transducer 110d, as shown in FIGS. 2(a) and 2(b), may be used with method 700 for determining an X-coordinate along the X-axis. With reference to FIG. 7, the method may begin at 705 and proceed to 710, where the circuitry may generate a second electrical excitation signal. At 715, the circuitry may transmit the second electrical signal to a second transmitting transducer, such as receiving transducer 110b, that is configured to transform the second electrical excitation signal into at least one second acoustic wave. At 720, the circuitry may receive a second electrical return signal from a second receiving transducer, such as receiving transducer 110d, where the second electrical return signal represents the second acoustic wave including a second attenuation that occurred while propagating through the sensor. At 725, the circuitry may process the second electrical return signal to determine a second coordinate (e.g., the X-axis coordinate) of a touch event on the sensor in touch region 205. The second coordinate and the first coordinate (i.e., the Y-axis coordinate) may comprise a coordinate pair. For example, the circuitry may be configured to then associate the coordinate pair with a display element shown on the display device. As such, the display device may be configured to present the display element while the first and second acoustic waves propagate through the sensor. The circuitry may be further configured to determine that a user has indicated a desire to select the display element, and method 700 may then end at 730.

FIG. 11 shows an example of a method 1100 for manufacturing an acoustic touch apparatus, performed in accordance with some embodiments. As such, an acoustic touch apparatus may be prepared using method 1100. Method 1100 may start at 1105 and proceed to 1110, where a substrate configured to propagate surface acoustic waves is provided. The substrate may have a front surface, a back surface, and a connecting surface joining the front surface and the back surface. In one example, a suitable substrate (e.g., having suitable thickness, opacity, acoustic response, or the like) such as substrate 105 as shown in FIG. 1a may be used.

At 1115, the front surface of the substrate is defined to have a front bowed edge. At 1120, the back surface of the substrate is defined to have a back bowed edge. The connecting surface may be between the front bowed edge and the back bowed edge. For example, a large substrate (e.g., a rectilinear substrate) may be cut to create a substrate having a non-rectilinear profile, e.g., at least one non-linear edge. As discussed above, the non-linear edge may include a bowed curvature that is concave and/or convex.

Next, the edges of the substrate may be rounded to further define the front bowed edge, the back bowed edge, and the curvature of the connecting surface between the front bowed edge and the back bowed edge. In some embodiments, a grinding tool may be used to grind the connecting surface to a desired curvature. Additionally or alternatively, the substrate may be polished to achieve smoother surfaces.

At 1125, a reflective array is provided on the back surface. As discussed above, there are many suitable ways of providing a reflective array on the back surface of a substrate such as by printing, etching, stamping, molding, or the like. In one example, the reflective arrays may be formed on the back surface, such as of a glass frit that is silk screening and cured in an oven to form raised perturbations of the glass surface. In some embodiments, glass fit is not actual glass, but a bonding material designed to be compatible with glass.

In some embodiments, the reflective array may be configured to cause the surface acoustic waves to propagate from the back surface, via the connecting surface, to the front surface. As discussed above, the reflective array may be configured to the curvature of substrate defined by the front bowed edge and the back bowed edge. Thus, distances between pairs of the reflector elements of the reflective array may vary between the beginning and the end of the reflective array. Furthermore, the reflector angles for at least two reflector elements in the reflective array may be different.

In some embodiments, an acoustically benign layer, may be applied to the substrate prior to forming the reflective array at 1125. As such, forming the reflective array at 1125 may be performed on the acoustically benign layer. Method 1100 may end at 1130,

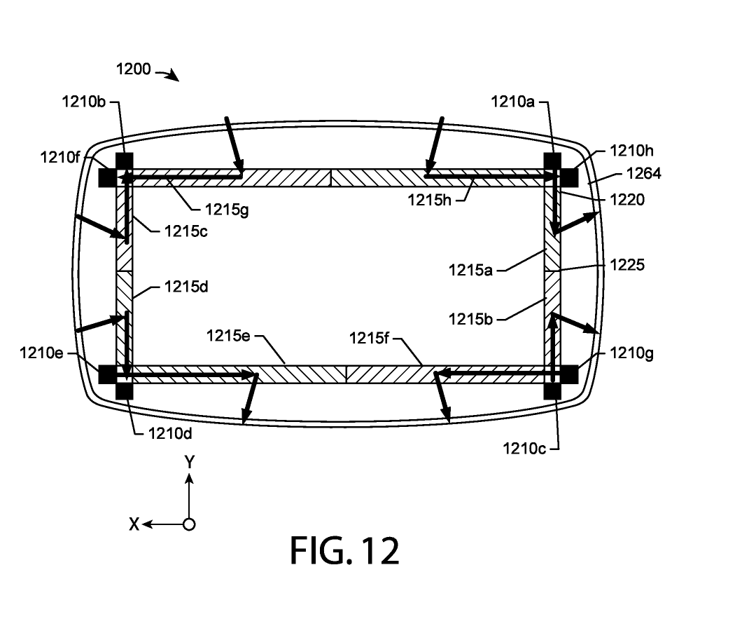

In some embodiments, the techniques described herein for touch sensors having one or more non-linear edges may be applied to large substrates (e.g., substrates larger than 50 inches diagonal). FIG. 12 shows a back view of an example large substrate of a touch sensor 1200, configured in accordance with some embodiments. Touch sensor 1200 includes eight transducers 1210 (i.e., transducers 1210a-h) and eight reflective arrays 1215 (i.e., reflective arrays 1215a-h). As such, acoustic wave paths are reduced, ensuring sufficient acoustic signal strength as the receiving transducers, as described in commonly-assigned U.S. Pat. No. 5,854,450, incorporated by reference above.

As shown in FIG. 12, reflective array 1215a is associated with transmitting transducer 1210a. Similar to as described above, transducer 1210a may define a beginning of reflective array 1215a (as shown at 1220) and an end of reflective array 1215a that is farther from transducer 1210a than the beginning (as shown at 1225). It is appreciated that reflective array 1215a does not run along the entire length of left edge 1264, but instead, terminates at the reflective array 1215b (as shown at 1225).

Reflective array 1215b is associated with transmitting transducer 1210c. As such. transmitting transducer 1210c may define a beginning of reflective array 1215b that is close to transducer 1210c (as shown at 1230) and an end of reflective array 1215b that is further from transducer 1210a than the beginning (as shown at 1225).

For the reflective arrays 1215 of touch sensor 1200, the techniques for reflector element overall spacing, spacing quantum and reflector angles also apply. In some embodiments, “beginning” and “end” in some embodiments may refer to the very beginning and the very end of a reflective array that spans the length of an associated edge. FIG. 12 illustrates, however, that the “beginning” and “end” of a reflective array, as used herein, may refer to relative locations of the reflective array defined with respect to distance away from an associated transducer. Furthermore, a reflective array may not necessarily run the entire length of an associated edge, such as in embodiments including large touch sensors for example.

Many modifications and other embodiments of the inventions set forth herein will come to mind to one skilled in the art to which these inventions pertain, having, the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An acoustic touch apparatus, comprising:
a substrate configured to propagate surface acoustic waves, the substrate having:
a front surface;
a back surface including a reflective array; and
a connecting surface joining the front surface and the back surface, wherein:
the front surface defines a front bowed edge;
the back surface defines a back bowed edge;
the connecting surface is between the front bowed edge and the back bowed edge; and
the reflective, array is configured to cause the surface acoustic waves to propagate from the back surface, via the connecting surface, to the front surface.

2. The acoustic touch apparatus of claim 1, further comprising, an acoustic wave transducer coupled to the back surface, wherein:
the reflective array defines a beginning and an end, the beginning being closest to the acoustic wave transducer and the end being the farthest from the acoustic wave transducer; and
the acoustic wave transducer is configured to generate and propagate the acoustic waves in the prevailing direction along the reflective array.

3. The acoustic touch apparatus of claim 2, wherein the reflective array includes a plurality of reflector elements disposed from beginning to end of the reflective array, wherein spacing quantum between pairs of the reflector elements vary between the beginning and the end of the reflective array.

4. The acoustic touch apparatus of claim 3, wherein the spacing quantum between pairs of reflectors elements become larger relative to the prevailing direction from the beginning of the reflective array to the end of the reflective array.

5. The acoustic touch apparatus of claim 3, wherein the spacing quantum between pairs of reflector elements become smaller relative to the prevailing direction from the beginning of the reflective array to the end of the reflective array.

6. The acoustic touch apparatus of claim 1, wherein the reflective array includes a plurality of reflector elements disposed along the reflective array, wherein each of the reflector elements has a reflector angle and reflector angles for at least two reflector elements are different.

7. The acoustic touch apparatus of claim 6, wherein the reflector angles become smaller for successive reflector elements relative to the prevailing direction from a beginning of the reflective array to an end of the reflective array.

8. The acoustic touch apparatus of claim 6, wherein the reflector angles becomes larger for successive reflector elements relative to the prevailing direction from a beginning of the reflective array to an end of the reflective array.

9. The acoustic touch apparatus of claim 1, wherein the front surface defining the front bowed edge defines a convex curvature.

10. The acoustic touch apparatus of claim 1, wherein the front surface defining the front bowed edge defines a concave curvature.

11. The acoustic touch apparatus of claim 1, wherein the front surface includes a touch region and further comprising:
a controller configured to determine a coordinate of a touch on the touch region based detected waveform attenuations of the surface acoustic waves as a function of time, the controller coupled with a receiving acoustic wave transducer configured to receive the waveform attenuations.

12. The acoustic touch apparatus of claim 11, wherein:
the reflective array is configured to cause each of the surface acoustic waves to be split into surface acoustic wave rays that are received by a receiving acoustic wave transducer at different times; and
the controller is configured to determine the coordinate of a touch on the touch region based on detected waveform perturbations of surface acoustic wave rays as a function of time.

13. The acoustic touch apparatus of claim 1 further comprising a transmitting acoustic, wave transducer and a receiving acoustic wave transducer.

14-15. (canceled)

16. The acoustic touch apparatus of claim 1 further comprising a display device positioned such that the display device is visible through the front surface of the substrate and wherein the front surface is bezelless.

17. The acoustic touch apparatus of claim 1, wherein an acoustic wave transducer and the reflective array are coupled to the back surface via an acoustically benign layer on the back surface.

18. (canceled)

19. The acoustic touch apparatus of claim 1, wherein the connecting surface is curved.

20. A method of manufacturing an acoustic touch apparatus, comprising:
providing a substrate configured to propagate surface acoustic waves, the substrate having:
a front surface;
a back surface; and
a connecting surface joining the front surface and the back surface;
defining the front surface to have a front bowed edge;
defining the back surface to have a back bowed edge, wherein the connecting surface is between the front bowed edge and the back bowed edge; and
provided a reflective array on the back surface, wherein the reflective array is configured to cause the surface acoustic waves to propagate from the back surface, via the connecting surface, to the front surface.

21-25. (canceled)

26. An acoustic touch apparatus prepared by a process, comprising:
providing a substrate configured to propagate surface acoustic waves, the substrate having:
front surface;
a back surface; and
a connecting surface joining the front surface and the back surface;
defining the front surface to have a front bowed edge;
defining the back surface to have a back bowed edge, wherein the connecting surface is between the frout bowed edge and the back bowed edge; and
providing a reflective array on the back surface, wherein the reflective array is configured to cause the surface acoustic waves to propagate from the back surface, via the connecting surface, to the front surface.

27. The acoustic touch apparatus of claim 26, the process further comprising:
cutting the substrate to have the bowed front edge and the bowed back edge;
curving the connecting surface between the bowed front edge and the bowed back edge; and
forming the reflective array on the back surface.

28. The acoustic touch apparatus of claim 27, wherein forming the reflective array comprises forming a plurality of reflector elements disposed from a beginning to an end of the reflective array, wherein spacing quantum between pairs of the reflector elements vary between the beginning and the end of the reflective array.

29-53. (canceled)
